(19) United States
(12) Patent Application Publication
(10) Pub. No.: US 2026/0152678 A1
(43) Pub. Date: Jun. 4, 2026

(54) EXPANDED CURE WINDOW CRASH DURABLE EPOXY ADHESIVES

(71) Applicant: Henkel AG & Co. KGaA, Duesseldorf (DE)

(72) Inventors: Bryan James Siegert, Lowell, MI (US); Nicholas Thomas Kamar, Trenton, MI (US); Syed Z. Mahdi, Rochester Hills, MI (US); Michael Klotz, Duesseldorf (DE); Girdhari Kumar, Troy, MI (US)

(21) Appl. No.: 19/343,804

(22) Filed: Sep. 29, 2025

Related U.S. Application Data
(63) Continuation of application No. PCT/US2024/021490, filed on Mar. 26, 2024.
(60) Provisional application No. 63/493,541, filed on Mar. 31, 2023.

(51) Int. Cl. C09J 163/00; C08G 59/40; C08G 59/62; C08K 3/22; C08K 3/34; C08K 3/36; C08K 5/21; C08K 5/521; C08K 5/5435; C09J 5/00

(52) U.S. Cl. CPC C09J 163/00; C08G 59/4021; C08G 59/623; C08K 3/346; C08K 3/36; C08K 5/21; C08K 5/521; C08K 5/5435; C09J 5/00; C08G 2170/00; C08K 2003/2206; C09J 2203/354; C09J 2463/00

(57) ABSTRACT

This invention is directed to single component (1K) epoxy-based adhesives capable of fully curing under broadened cure conditions.

### TECHNICAL FIELD

The disclosure is directed to crash-durable epoxy-based adhesive compositions curable under broad time/temperature conditions; methods of preparing a cured adhesive, and products.

### BACKGROUND

Single component (1K) epoxy adhesives contain heat activated latent hardeners (also referred to as curing agents), such as dicyandiamide (DICY), which are relatively inactive at ambient temperature. Single component adhesives may also contain a latent catalyst or accelerator in addition to the curing agent to catalyze/accelerate adhesive cure upon beating. Known single component storage stable and ‘crash durable’ structural adhesives have reaction onset temperatures of 160° C. or higher and OEMs require them to exhibit good crash durability properties (including at sub-ambient temperatures as low as −30° C. or even −40° C.) after cure at 155° C. for 10 min. or 190° C. for 60 min., respectively. A need to reduce reaction onset temperature, while retaining ambient storage stability of these single component epoxy structural adhesives has arisen to support lower energy consumption.

To date, single component epoxy adhesive formulations using catalysts or accelerators for dicyandiamide (DICY) cure of epoxy resins do not provide the desired combination of cured epoxy impact resistant performance from a storage stable adhesive with reduced onset temperature. Existing single component epoxy adhesives do not fully cure and develop ‘full spectrum’ impact properties, as described herein, when baked at 140° C.′ for about 15 min. ‘Full spectrum’ impact properties as used herein refers to adequate adhesion and impact resistance exhibited by the cured composition across a range of test temperatures as high as 80° C. to as low as −30° C. or even −40° C.

Adipic dihydrazide (ADH) has been incorporated into one-component toughened epoxy adhesives containing a mixture of latent curing agents. However, results show poor adhesion properties under lower temperature cure conditions and/or poor full spectrum impact properties; relatively high concentrations of ADH are required for cure under lower temperature cure conditions.

2,4,6-tris(dimethylaminomethyl)phenol a catalyst and curing agent results in epoxy curing at ambient temperature making it unsuitable for a 1K epoxy. US9000120B2 discloses that this tertiary amine may be made latent when mixed with a novolac resin, but has poor storage stability. High concentrations (>3 wt. %) of blocked tertiary amines based on phenol exhibit increased viscosity during storage and poor adhesion to steel and aluminum substrates.

In some cases, incorporation of imidazoles is described. For example, U.S. Pat. No. 9,546,243B2, teaches that latent epoxy curing agents may comprise an imidazole and an amine such as 2,4,6-tris(dimethylaminomethyl)phenol that forms solutions with polyphenolic resins including polymers or co-polymers of phenols substituted by an unsaturated ethylene group or polymers and copolymers of phenol substituted acrylates or methacrylates or polymers of vinylphenols and propenylphenols. It was suggested that phenolic resins may also comprise co-polymers of such unsaturated phenols with other polymerizable alkene-substituted compounds such as styrene, γ-methylstyrene, acrylic esters, methacrylic esters and vinyl esters. However, imidazoles are not advantageous in crash durable epoxy adhesives, since they induce homopolymerization of the epoxy network resulting in the formation of a brittle thermoset upon cure.

High concentrations of modified ureas also have been attempted for use in such compositions. However, modified ureas result in poor shelf life due to increased viscosity during storage prior to dispense and cure, poor adhesion to steel and aluminum surfaces and/or poor impact properties when cured under ‘overbake’, e.g. 190° C. for 60 min., conditions, especially when cured bonds are tested at sub-ambient temperatures.

Thus, a need exists for a single package (so called “1K”) epoxy adhesive composition with reduced onset temperature that is storage stable at ambient temperature and exhibits “full spectrum” cured impact resistant performance whether cured at 140° C. for 15 min. (low bake) or at 190° C. for 60 min. (high bake) conditions. The present disclosure addresses at least some of these needs.

### SUMMARY

The disclosure is directed to new compositions of matter, including liquid epoxy-based structural adhesives that upon cure provide stress resistant, preferably crash durable, cured bonds useful in adhering substrates, e.g. metal substrates, together. Also provided are bonded assemblies derived by applying the uncured adhesive to one or both substrates to be bonded, bringing the substrates into contact such that the adhesive is located between the substrates to be bonded and curing the adhesive, and methods of making these liquid epoxy-based adhesives, methods of bonding substrates and articles of manufacture comprising the bonded assemblies. Various embodiments of the invention are described throughout this disclosure including:

Embodiment 1. A structural adhesive composition useful in vehicle construction comprising, consisting essentially of or consisting of:
(i) an epoxy resin comprising a diglycidyl ether of a substituted or unsubstituted bisphenol;
(ii) latent reactant;
(iii) a modified urea accelerator;
(iv) dicyandiamide;
(v) at least one toughening agent;
(vi) optionally at least one filler; and
(vii) optionally an epoxy resin different from (i).

Embodiment 2. The adhesive composition of Embodiment 1, wherein the epoxy resin (i) has an epoxide equivalent weight (EEW) of about 150 to about 225.

Embodiment 3. The adhesive composition of Embodiment 2, wherein the epoxy resin (i) has an EEW of about 170 to about 200.

Embodiment 4. The adhesive composition of Embodiment 2, wherein the epoxy resin (i) has an EEW of about 185 to about 192.

Embodiment 5. The adhesive composition of Embodiment 2, wherein the epoxy resin (i) has an EEW of about 172 to about 179.

Embodiment 6. The adhesive composition of any one of the preceding Embodiments, wherein the epoxy resin (i) comprises a diglycidyl ether of a substituted or unsubstituted bisphenol, preferably is a diglycidyl ether of bisphenol-A (DGEBA), a diglycidyl ether of bisphenol F (DGEBF) of combinations thereof.

Embodiment 7. The adhesive composition of any one of the preceding Embodiments, comprising one epoxy resin.

Embodiment 8. The adhesive composition of any one of Embodiments 1-6, comprising two epoxy resins.

Embodiment 9. The adhesive composition of any one of Embodiments 1-6, comprising three epoxy resins.

Embodiment 10. The adhesive composition of any one of Embodiments 1-6, comprising four or more epoxy resins.

Embodiment 11. The adhesive composition of any one of the preceding Embodiments, comprising about 30 to about 60 wt. %, based on the weight of the composition, of the epoxy resin (i).

Embodiment 12. The adhesive composition of any one of the preceding Embodiments, wherein the latent reactant is a heat activatable reagent comprising is a modified polymeric tertiary amine having an activation temperature in a range of about 120° C. to about 138° C.

Embodiment 13. The adhesive composition of Embodiment 12, wherein the latent reactant is a heat activatable reagent comprising a tertiary amine, a polyhydroxyphenylalkyl polymer resin and a supplemental organic agent.

Embodiment 14. The adhesive composition of Embodiment 12 or 13, wherein the supplemental organic agent comprises an oligomer or a polymer comprising acryl moieties.

Embodiment 15. The adhesive composition of Embodiment 12 or 13, wherein the tertiary amine comprises at least one hydroxyl substituent;

Embodiment 16. The adhesive composition of Embodiment 12 or 13, wherein the tertiary amine comprises an aromatic ring and an acrylate.

Embodiment 17. The adhesive composition of Embodiment 12 or 13, wherein the tertiary amine comprises an aromatic ring having 1-3 tertiary amine functional groups, optionally further comprising at least one hydroxyl substituent.

Embodiment 18. The adhesive composition of Embodiment 12 or 13, wherein the tertiary amine comprises one or more of mono-, di- or tris-(dialkylaminomethyl)-phenol.

Embodiment 19. The adhesive composition of Embodiment 12 or 13, wherein the tertiary amine comprises 2,4,6-tris-(dimethylaminomethyl)-phenol.

Embodiment 20. The adhesive composition of any one of the preceding Embodiments, comprising about 0.5 to about 5 wt. %, based on the weight of the composition, of the latent reactant.

Embodiment 21. The adhesive composition of any one of the preceding Embodiments, wherein the modified urea accelerator comprises a dimethylurea.

Embodiment 22. The adhesive composition of any one of the preceding Embodiments, comprising about 0.2 to about 3 wt. %, based on the weight of the composition, of the modified urea accelerator.

Embodiment 23. The adhesive composition of any one of the preceding Embodiments, comprising about 2 to about 6 wt. %, based on the weight of the composition, of the dicyandiamide.

Embodiment 24. The adhesive composition of any one of the preceding Embodiments, wherein the toughening agent comprises at least one carboxyl terminated butadiene acrylonitrile (CTBN), optionally adducted with DGEBF and/or DGEBA.

Embodiment 25. The adhesive composition of Embodiment 24, comprising about 1 to about 20 wt. %, based on the weight of the composition, of the toughening agent.

Embodiment 26. The adhesive composition of any one of the preceding Embodiments, further comprising core shell rubber (CSR) particles solid toughening agent, optionally dispersed in an epoxy resin.

Embodiment 27. The adhesive composition of Embodiments 26, wherein the CSR particles are nano core shell rubber particles.

Embodiment 28. The adhesive composition of Embodiment 26 or 27, wherein the CSR particles are dispersed in DGEBA.

Embodiment 29. The adhesive composition of Embodiment 28, comprising about 40 to about 45 wt. %, based on the weight of the CSR particles in DGEBA, of CSR particles.

Embodiment 30. The adhesive composition of any one of Embodiments 26-29, comprising about 20 to about 25% by weight, based on the weight of the composition, of CSR particles.

Embodiment 31. The adhesive composition of any one of the preceding Embodiments, further comprising a flexibilizer wherein the flexibilizer is a polyetheramine-DGEBA adduct.

Embodiment 32. The adhesive composition of any one of the preceding Embodiments, comprising a polyurethane toughening agent.

Embodiment 33. The adhesive composition of Embodiment 32, wherein the polyurethane toughening agent is a blocked polyurethane toughening agent.

Embodiment 34. The adhesive composition of Embodiment 32 or 33, wherein the toughening agent comprises one or more polyurethane pre-polymers based on (poly(tetramethylene ether)glycol and/or polybutadiene, optionally end-capped.

Embodiment 35. The adhesive composition of any one of Embodiments 32-34, comprising about 0.1 to about 34 wt. %, based on the weight of the composition, of the polyurethane toughening agent.

Embodiment 36. The adhesive composition of any one of Embodiments 32-35, comprising about 2 to about 30 wt. %, based on the weight of the composition, of the polyurethane toughening agent.

Embodiment 37. The adhesive composition of any one of the preceding Embodiments, further comprising a phosphorus adhesion promoter.

Embodiment 38. The adhesive composition of Embodiment 37, wherein the phosphorus adhesion promoter comprises a substituted or unsubstituted triphenyl phosphate.

Embodiment 39. The adhesive composition of Embodiment 37, wherein the phosphorus adhesion promoter comprises at least one tris(alkylphenyl) phosphate.

Embodiment 40. The adhesive composition of Embodiment 37, wherein the phosphorus adhesion promoter comprises one or more of tris(4-isopropylphenyl) phosphate, tris[4-(2-methylpropyl)phenyl]phosphate, or triphenyl phosphate.

Embodiment 41. The adhesive composition of any one of Embodiments 37-40, comprising about 0.5 to about 5 wt. %, based on the weight of the composition, of the phosphorus adhesion promoter.

Embodiment 42. The adhesive composition of any one of the preceding Embodiments, further comprising a silane adhesion promoter.

Embodiment 43. The adhesive composition of Embodiment 42, wherein the silane adhesion promoter is 3-glycidyloxypropyltrimethoxy silane (GLYMO).

Embodiment 44. The adhesive composition of Embodiment 42 or 43, comprising about 0.1 to about 0.3 wt. %, based on the weight of the composition, of the silane adhesion promoter.

Embodiment 45. The adhesive composition of any one of the preceding Embodiments, wherein the filler is an inorganic filler.

Embodiment 46. The adhesive composition of Embodiment 45, wherein the inorganic filler is a desiccant, thixotrope, or a combination thereof.

Embodiment 47. The adhesive composition of Embodiment 45 or 46, wherein the inorganic filler is calcium oxide, calcium metasilicate, mica, mixed mineral thixotrope, hydrophobic surface treated fumed silica, hollow glass microspheres, or a combination thereof.

Embodiment 48. The adhesive composition of any one of Embodiments 45-47, comprising about 1 to about 35 wt. %, based on the weight of the composition, of the inorganic filler.

Embodiment 49. The adhesive composition of any one of Embodiments 45-47, comprising about 1 to about 10 wt. %, based on the weight of the composition, of calcium oxide.

Embodiment 50. The adhesive composition of any one of Embodiments 45-47, comprising about 1 to about 10 wt. %, based on the weight of the composition, of calcium metasilicate.

Embodiment 51. The adhesive composition of any one of Embodiments 45-47, comprising about 0.1 to about 1 wt. %, based on the weight of the composition, of mica.

Embodiment 52. The adhesive composition of any one of Embodiments 45-47, comprising about 0.1 to about 1 wt. %, based on the weight of the composition, of a mixed mineral thixotrope.

Embodiment 53. The adhesive composition of any one of Embodiments 45-47, comprising about 1 to about 8 wt. %, based on the weight of the composition, of hydrophobic surface treated fumed silica.

Embodiment 54. The adhesive composition of any one of Embodiments 45-47, comprising about 0.5 to about 3 wt. %, based on the weight of the composition, of hollow glass microspheres.

Embodiment 55. The adhesive composition of any one of the preceding Embodiments, wherein the epoxy resin different from (i) is a novolac epoxy resin having an EEW ranging from 172 to 225.

Embodiment 56. The adhesive composition of any one of the preceding Embodiments, wherein the adhesive composition lacks an accelerator that is an imidazole, dihydroxybenzene, adipic anhydride, phosphonium ionic liquid, blocked tertiary amine based on the phenol lacking an acrylate, polyamine salts of polyhydric phenols, or a combination thereof.

Embodiment 57. The adhesive composition of any one of the preceding Embodiments, which is storage stable at ambient temperatures, preferably stable in a range of 15° C. to 30° C.

Embodiment 58. A method of preparing a cured adhesive, comprising heating the adhesive composition of any one of the preceding Embodiments to a temperature of about 140° C. to about 150° C.

Embodiment 59. The method of Embodiment 58, wherein the adhesive composition is heated to about 140° C. for 15 minutes.

Embodiment 60. The method of Embodiment 58 or 59, further comprising heating to 190° C. for 60 minutes.

Embodiment 61. A product prepared using the method of any one of Embodiments 58-60.

Embodiment 62. An article of manufacture comprising a first surface and a second surface and sandwiched between the first and second surfaces and adhering them together is a cured layer of the adhesive composition according to any of one of Embodiments 1-57.

Embodiment 63. The article of manufacture of Embodiment 62, wherein one or both of the first and second surfaces comprises metal surfaces, composite surfaces or a combination thereof.

Embodiment 64. The article of manufacture of Embodiment 62, wherein one or both of the first and second surfaces comprises metal, coated metal, aluminum, plastic, filled plastic, or fiberglass surfaces.

Embodiment 65. A steel or aluminum surface containing the adhesive composition of any one of Embodiments 1-57.

Embodiment 66. The steel or aluminum surface of Embodiment 65, wherein the adhesive composition is adhered to the surface.

Embodiment 67. The steel or aluminum surface of Embodiment 65, that is component of an aerospace, automotive, marine, locomotive or construction vehicle, preferably an automobile component.

In some embodiments, the disclosure provides an adhesive composition comprising (i) an epoxy resin comprising a diglycidyl ether of a substituted or unsubstituted bisphenol; (ii) latent reactant; (iii) a modified urea accelerator; (iv) dicyandiamide; (v) at least one toughening agent; (vi) optionally at least one filler; and (vii) optionally an epoxy resin different from (i).

In other embodiments, the disclosure provides methods of preparing a cured adhesive, comprising heating the adhesive composition described herein to a temperature of about 140° C. to about 190° C., preferably at least, in increasing order of preference, about 135, 136, 137, 138, 139, 140, 141, 142, 143, 144, 145 or 150° C.

In further embodiments, the disclosure provides products prepared using the methods described herein. In yet other embodiments, the disclosure provides metal surfaces, such as steel, galvanized or aluminum surfaces comprising the adhesive composition described herein.

### BRIEF DESCRIPTION OF THE DRAWINGS

FIG. 1 is a line graph showing extent of cure as a function of time for Examples 1 to 4.

FIG. 2 is dynamic mechanical analysis (DMA) after high bake (HB) cure of Examples 2 and 4.

FIG. 3 is a line graph showing extent of cure as a function of time for Examples 2, 5 and 6.

FIG. 4 is a line graph showing extent of cure as a function of time for Examples 2, 7 and 8.

FIG. 5A shows DMA results after HB cure of Examples 2 and 4 and FIG. 5B shows DMA results after HB cure of Examples 2 and 8.

FIG. 6 is a line graph showing extent of cure as a function of time for Examples 9, 10 and 11.

### DETAILED DESCRIPTION OF ILLUSTRATIVE EMBODIMENTS

The presently disclosed inventive subject matter may be understood more readily by reference to the following detailed description taken in connection with the accompanying figures and examples, which form a part of this disclosure. It is to be understood that these inventions are not limited to the specific components, methods, or parameters described and/or shown herein, and that the terminology used herein is for the purpose of describing particular embodiments by way of example only and is not intended to be limiting of the claimed inventions.

The epoxy adhesive compositions described herein provide one or more of the significant improvements discussed above. In some embodiments, the compositions are storage stable and heat cure across a wide range of time/temperature conditions (cure window), preferably at both extreme ‘corners’ of the cure window of interest. For example, the compositions preferably can be cured at low bake, 140° C. for 15 min., or at high bake, 190° C. for 60 min. and still exhibit good lap shear, T-peel and/or impact properties, preferably at sub-ambient temperatures, e.g. −30° C. or even −40° C. This is an improvement compared to currently available 1K crash durable adhesives which require a minimum time/temperature cure condition of 155° C. to 160° C. for 10 min. and their performance is negatively affected by overbake such as at 190° C. for 60 min. In other embodiments, the compositions have a good reactivity at 140° C. and good storage stability. This contrasts with known epoxy adhesive compositions which do not fully cure and develop ‘full spectrum’ impact properties when heated cured at lower temperatures such as 140° C. for 15 min.

Additionally, it was surprisingly found that the use of lower concentrations of latent reactant and modified urea accelerator in combination provided the desired cure kinetics, storage stability, network properties including glass transition temperature (T_{g}), good T-peel adhesion, lap shear adhesion and/or impact properties across the expanded cure window of interest.

### Adhesive Compositions

As described herein, new adhesive compositions are provided and have improvements in both storage stability and reactivity.

The disclosure provides adhesive compositions comprising an epoxy resin comprising a diglycidyl ether of a substituted or unsubstituted bisphenol; latent reactant; a modified urea accelerator; dicyandiamide; at least one toughening agent; optional at least one filler; and optional epoxy resin different from (i).

The adhesive compositions described herein are storage stable at “ambient temperatures”, meaning approximately a room temperature of about 15 to about 25° C., or such as about 20° C. or 23° C. Stability of the adhesive compositions may be measured using skill in the art. Generally, accelerated aging techniques, e.g. heating the adhesive to a temperature greater than ambient, but less than reaction onset temperature, may be used to determine shelf life at ambient temperature by known methods. For example, the viscosity of an adhesive composition may be measured using techniques such as parallel plate rheology (5000 Pa*s, 15° C., 3 l/s shear rate (constant), value for 180 seconds) to determine if acceptable viscosities are maintained after 7 days at 35-40° C. or after other suitable time/temperature aging conditions.

### A. Epoxy Resin

According to the disclosure, the adhesive compositions contain an epoxy resin comprising a diglycidyl ether of a substituted or unsubstituted bisphenol. In some embodiments, the epoxy resin comprises a diglycidyl ether of a substituted bisphenol. In other embodiments, the epoxy resin comprises a diglycidyl ether of an unsubstituted bisphenol. In further embodiments, the epoxy resin may be a diglycidyl ether of bisphenol-A (DGEBA), a diglycidyl ether of bisphenol F (DGEBF) or combinations thereof. Other suitable polyphenols as the basis for the polyglycidyl ethers are the known condensation products of phenol and formaldehyde or acetaldehyde of the novolac resin-type. In some embodiments, the epoxy resin may be the liquid epoxy resins derived by reaction of bisphenol A or bisphenol F and epichlorohydrin. The epoxy resins that are liquid at room temperature generally have epoxy equivalent weights of about 150 to about 480. In other embodiments, one or more of diglycidyl ether of the bisphenol-A (DGEBA) epoxy resins or bisphenol-F (DGEBF) epoxy resins may be present individually or together. Suitable commercially available polyphenol polyglycidyl ether products include diglycidyl ethers of bisphenol A resins such as are sold by Olin Corporation under the tradename D.E.R.®, including the 300 and 600 series resins, or products such as Epon 828 or Kukdo YD-128. Other aliphatic epoxy diluents/flexibilizers, from the D.E.R.® 700 series, may also be incorporated to decrease viscosity (i.e., as a diluent), to increase flexibility/elongation and improve adhesion.

The epoxy resin may have an epoxide equivalent weight (EEW), determined according to Formula I:

$$EEW = \frac{M W epoxy resin}{number of epoxy groups} . \qquad ( I )$$

In some embodiments, the epoxy resin has an EEW of preferably at least about 125, 150, 160, 170, 180, and independently preferably not more than about 190, 200, 210, 220, 230, 235, 240 or 250. In other embodiments, the epoxy resin has an EEW of about 150 to about 225 or about 170 to about 200. In further embodiments, the epoxy resin has an EEW of about 185 to about 192. In still other embodiments, the epoxy resin has an EEW of about 172 to about 179.

The adhesive composition may contain the epoxy resin in an amount of about 30 wt. % to about 60 wt. %, based on weight of the composition. In some embodiments, the adhesive composition contains about 30, about 35, about 40, about 45, about 50, about 55, or about 60) wt. %, based on the weight of the composition, of the epoxy resin. In other embodiments, the adhesive composition contains about 30 to about 55, about 30 to about 50, about 30 to about 45, about 30 to about 40, about 30 to about 35, about 35 to about 60, about 35 to about 55, about 35 to about 50, about 35 to about 45, about 35 to about 40, about 40 to about 60, about 40 to about 55, about 40 to about 50, about 40 to about 45, about 45 to about 60, about 45 to about 55, about 45 to about 50, about 50 to about 60, about 50 to about 55, or about 55 to about 60 wt. %, based on the weight of the composition, of the epoxy resin.

### B. Latent Reactant

The adhesive compositions also contain a latent reactant, which may be heat activatable. The term “latent reactant” as used herein refers to a reagent that reacts with or facilitates reaction between other components of the adhesive composition when subjected to a change in temperature, pH or solubility. These reagents are sometimes referred to in the literature as catalysts or accelerators; the “Latent Reactant B.”, described herein, is different from “C. Modified Urea Accelerator” described below and in preferred embodiments both “B.” and “C.” are present in the epoxy adhesive compositions.

The term “heat activatable reagent” refers to a chemical reagent that, when subject to a predetermined temperature as described herein, reacts with or facilitates reaction between the other components of the adhesive composition. In the inventive epoxy adhesives, a desirable caring temperature is about 140° C.′, and may be lower provided adhesive performance & ambient storage stability is not unacceptably reduced. Reaction onset temperature, with at least some of the latent reactant being activated at or below that temperature, may be in a range of about 130° C.-138° C. In some embodiments, the latent reactant may be a beat activatable reagent comprising a latent, e.g. blocked, encapsulated or otherwise rendered reversibly inactive, tertiary amine. Desirably, the latent reactant may be heat activatable in a temperature range of at least in increasing order of preference about 100, 110, 120, 125, or 130° C., and up to about 131, 132, 133, 134, 135, 136, 137, or 138° C. The latent reactant desirably comprises a modified polymeric tertiary amine. In a preferred embodiment the latent reactant comprises a tertiary amine; polyhydroxyphenylalkyl polymer or resin, e.g. a novolac resin; and a supplemental organic agent. In one embodiment, the supplemental organic agent may comprise an oligomer or a polymer comprising acryl moieties, e.g. acrylic polymer. As used herein, the term “acryl” refers to an α,β-unsaturated carbonyl compound, i.e., containing a carbon-carbon double bond and a carbon-oxygen double bond, separated by a carbon-carbon single bond. In certain aspects, the acryl may be an acrylate, i.e., CH₂═CHC(O)O—. In other aspects, the acryl may be an acryloyl group. i.e., CH₂═CHC(O)—. In further aspects, the acryl may be a polymer or co-polymer of phenols substituted by an unsaturated ethylene group such as 2-allylphenol, 4-allylphenol or polymers and copolymers of phenol substituted acrylates or phenol substituted methacrylates or polymers of vinylphenols and propenylphenols, as described in U.S. Pat. No. 9,546,243B2. Suitable phenolic resins may also comprise co-polymers of such unsaturated phenols with other polymerizable alkene-substituted compounds such as styrene, γ-methylstyrene, acrylic esters, methacrylic esters and vinyl esters. Examples of the latent reactants include, without limitation, Technicure LC-100 described as a modified polymeric tertiary amine having an avg. particle size of 10 micron and MP of 90-100° C., as well as compositions containing Ancamine® K54, a 2,4,6-tris-(dimethylaminomethyl)-phenol+Alvonol® PN 320, a phenolic resin.

The tertiary amine comprises at least one hydroxyl substituent. In some embodiments, the tertiary amine may comprise an aromatic ring and an acrylate. The term “aromatic ring” as used herein refers to a phenyl ring that is optionally substituted. In some embodiments, the tertiary amine comprises an aromatic ring having 1-3 tertiary amine functional groups, optionally further comprising at least one hydroxyl substituent. In further embodiments, the tertiary amine may comprise one or more of mono-, di- or tris-(dialkylaminomethyl)-phenol. In other embodiments, the tertiary amine comprises 2,4,6-tris-(dimethylaminomethyl)-phenol. In still further embodiments, the latent reactant may be Ancamine® 2920 (Evonik Corp.) described by the manufacturer as an encapsulated accelerator comprising tertiary amine, polyhydroxyphenylalkyl polymer and acrylic polymer. In certain aspects, the latent reactant component contains about 25 to about 50 wt. % of a tertiary amine. In other embodiments, the latent reactant contains about 25 to about 50 wt. % of the polyhydroxyphenylalkyl polymer. In further embodiments, the latent reactant contains about 25 to about 50 wt. %, of an acrylic polymer.

The adhesive composition desirably contains about 0.25 to about 3 wt. %, based on the weight of the composition, of the latent reactant described herein as an encapsulated accelerator comprising tertiary amine, polyhydroxyphenylalkyl polymer and acrylic polymer. In other embodiments, the adhesive composition contains at least, in increasing order of preference, about 0.5, 1, 1.5, or 2 wt. % and no greater than, in increasing order of preference, about 5, 4.5, 4, 3.5, 3, 2.5, or 2.25 wt. % based on the weight of the composition, of latent reactant, which provides onset temperatures as described herein. For example, a latent reactant comprising epoxy amine adduct, desirably may be present in amounts of about 5.0 to about 3.0, about 5.0 to about 3.5, about 5.0 to about 4.0, about 4.75 to about 2.5, about 4.75 to about 3.0, about 4.75 to about 3.5, about 4.75 to about 3.75, about 4.5 to about 3.5, about 4.5 to about 3.75 wt. %, of the latent reactant. In further embodiments, the adhesive composition contains about 2 to about 3.5 wt. %, based on the weight of the composition, of the latent reactant.

In some embodiments, the latent reactant may be prepared according to methods known in the art, see U.S. Pat. Nos. 9,000,120 and 9,546,243, for example by dissolving a novolac or other polyphenol resin into the tertiary amine (optionally in the presence of an acrylate oligomer or polymer) with heating followed by cooling. The resultant solid solution of components may then be ground to a desired particle size.

### C. Modified Urea Accelerator

The epoxy adhesive compositions contain a modified urea accelerator. The term “modified urea” as used herein refers to a compound comprising urea group i.e., NH₂C(O)NH, that contains a substituent on one or more positions of the molecule. Typically, one or more of the hydrogens bonded to the urea nitrogen atoms is replaced with alkyl or aryl groups, which may be the same or different from each other. In some embodiments, the modified urea accelerator is a methylated urea. In other embodiments, the modified urea accelerator comprises a dimethylurea, e.g., 1,1-dimethylurea, (CH₃)₂NC(O)NH₂; 1,3-dimethylurea; 4,4′ methylene bis-(phenyl dimethyl urea), aryldimethylurea compounds such as diuron and monuron, cycloaliphatic dimethyl ureas, or aliphatic dimethyl ureas, among others. In further embodiments, the modified urea accelerator is dimethylurea.

In certain embodiments, the modified urea accelerator may be dimethyl urea and the latent reactant may be Ancamine® 2920.

The adhesive composition contains about 0.2 to about 3 wt. %, based on the weight of the composition, of the modified urea accelerator. In some embodiments, the adhesive composition contains about 0.2, 0.5, 1, 1.5, 2, 2.5, or 3 wt. %, based on the weight of the composition, of the modified urea accelerator. In other embodiments, the adhesive composition contains about 0.2 to about 3, about 0.2 to about 2.5, about 0.2 to about 2, about 0.2 to about 1.5, about 0.2 to about 1, about 0.2 to about 0.5, about 0.5 to about 3, about 0.5 to about 2.5, about 0.5 to about 2, about 0.5 to about 1.5, about 0.5 to about 1, about 1 to about 3, about 1 to about 2.5, about 1 to about 2, about 1 to about 1.5, about 1.5 to about 3, about 1.5 to about 2.5, about 1.5 to about 2, about 2 to about 3, about 2 to about 2.5, or about 2.5 to about 3 wt. %, based on the weight of the composition, of the modified urea accelerator. In further embodiments, the adhesive composition contains about 0.2 to about 1 wt. %, based on the weight of the composition, of the modified urea accelerator.

### D. Dicyandiamide

According to the disclosure, the adhesive compositions contain a curing agent such as dicyandiamide (DICY). The adhesive compositions may be one-part or single-component compositions, containing one or more curing agents capable of accomplishing cross linking or curing of certain of the adhesive components when the adhesive is heated to an activation temperature of the curing agent and/or latent reactants and/or accelerators. To ensure good storage stability of the single-component epoxy adhesive, the DICY curing agent has low solubility in the epoxy resins at room temperature, rendering it latent until heated. Solid, finely ground curing agents can permit ready dissolution at about the activation temperature, dicyandiamide (DICY) being especially suitable. In certain embodiments, the DICY of the liquid epoxy adhesive compositions may comprise a micronized dicyandiamide (cyanoguanidine). The use of micronized dicyandiamide can ensure reactivity with epoxy during and after melting of the DICY, since DICY is insoluble in epoxy resins prior to melting. In certain embodiments, at least 98% of the micronized dicyandiamide has a particle size of 40 microns or less. In other embodiments, at least 98% of the micronized dicyandiamide has a particle size of 10 microns or less. In other embodiments, at least 98% of the micronized dicyandiamide has a particle size of 6 microns or less. Such materials are commercially available from AlzChem, under the tradename Dyhard®.

In some embodiments, the adhesive composition contains about 2 to about 5.5 wt. %, based on the weight of the composition, of DICY. In other embodiments, the adhesive composition contains at least, in increasing order of preference, about 1.5, 1.75, 2, 2.5 or 3 wt. %, and no greater than, in increasing order of preference, about 3.5, 4, 4.5, 5, 5.5, or 6 wt. % of DICY based on the weight of the composition. In further embodiments, the adhesive composition contains about 2 to about 6, about 2 to about 5.5, about 2 to about 5, about 2 to about 4.5, about 2 to about 4, about 2 to about 3.5, about 2 to about 3, about 2 to about 2.5, about 2.5 to about 6, about 2.5 to about 5.5, about 2.5 to about 5, about 2.5 to about 4.5, about 2.5 to about 4, about 2.5 to about 3.5, about 2.5 to about 3, about 3 to about 6, about 3 to about 5.5, about 3 to about 5, about 3 to about 4.5, about 3 to about 4, about 3 to about 3.5, about 3.5 to about 6, about 3.5 to about 5.5, about 3.5 to about 5, about 3.5 to about 4.5, about 3.5 to about 4, about 4 to about 6, about 4 to about 5.5, about 4 to about 5, about 4 to about 4.5, about 4.5 to about 6, about 4.5 to about 5.5, about 4.5 to about 5, about 5 to about 6, about 5 to about 5.5, or about 5.5 to about 6 wt. %, based on the weight of the composition, of DICY. In further embodiments, the adhesive compositions contain about 2 to about 5.5 wt. %, based on the weight of the composition, of DICY. In yet other embodiments, the adhesive composition contains about 3 to about 4 wt. %, based on the weight of the composition, of DICY.

### E. At Least One Toughening Agent

The adhesive composition described herein also contains at least one toughening agent, preferably a plurality of toughening agents. Total toughening agent may range in an amount of from 15 wt. % to 40 wt. % depending on the toughening components selected. In some embodiments, the toughing agent comprises at least one carboxyl terminated butadiene acrylonitrile (CTBN), at least one polyurethane pre-polymer and optionally Core Shell Rubber (solid toughener). In other embodiments, the toughening agent comprises one or more polyurethane pre-polymer based on (poly(tetramethylene ether)glycol and/or polybutadiene, which may be end-capped.

### Carboxyl Terminated Butadiene Acrylonitrile (CTBN Toughening Agent)

The adhesive composition described herein also may contain at least one toughening agent, preferably a plurality of toughening agents. In some embodiments, the toughing agent comprises at least one carboxyl terminated butadiene acrylonitrile (CTBN), optionally adducted with DGEBF and/or DGEBA. In other embodiments, the CTBN comprises a copolymer of butadiene and a nitrile monomer, such as acrylonitrile or may comprise a homopolymer of butadiene. Higher acrylonitrile content may be in a range of about 22 to about 30 wt. % based on weight of the CTBN, and in some preferred embodiments, the CTBN compositions contain about 26 wt. % acrylonitrile thereby increasing miscibility between the CTBN adduct and the epoxy resin. In certain aspects, the increased solubility retards onset (kinetics) of phase separation during cure, resulting in a smaller rubber domain size and increased fracture toughness. Preferably, at least a portion of the CTBN toughener does not phase separate into rubber domains, instead remaining distributed in the epoxy matrix where it can contribute flexibility to the cured matrix.

Carboxyl-terminated butadiene acrylonitriles (CTBN) may contain about 1.5, or about 1.8, to about 2.5, or about 2.2 functionality, and acrylonitrile content ranges from about 20 to about 28%, or about 26%. The molecular weight (Mₙ) of the butadiene acrylonitrile copolymer is suitably about 2000 to about 6000, or such as about 3000 to about 5000. Suitable carboxyl-functional butadiene and butadiene/acrylonitrile copolymers are commercially available from Huntsman under the tradenames Hycar® and Hypro®. In some embodiments, a portion of the one or more carboxyl-terminated butadiene acrylonitrile (CTBN) may be adducted with DGEBA or DGEBF, see suitable commercially available adducts from Huntsman under tradename Hypox™. The adduct may be dissolved or dispersed in novolac epoxy resin which aids solubility. In other embodiments, the CTBN may be a CTBN-DGEBF adduct in epoxy resin. In further embodiments, the CTBN may be optionally dissolved in DGEBF.

In some embodiments, the adhesive composition contains about 1 to about 20 wt. %, based on the weight of the composition, of the toughening agent. In other embodiments, the adhesive composition contains about 1, about 2, about 3, about 4, about 5, about 6, about 7, about 8, about 9, about 10, about 11, about 12, about 13, about 14, about 15, about 16, about 17, about 18, about 19, or about 20 wt. %, based on the weight of the composition, of the toughening agent. In further embodiments, the adhesive composition contains about 1 to about 15, about 1 to about 10, about 1 to about 5, about 5 to about 20, about 5 to about 15, about 5 to about 10, about 10 to about 20, about 10 to about 15, or about 15 to about 20 wt. %, based on the weight of the composition, of the toughening agent. In yet other embodiments, the adhesive composition contains about 5 to about 10 wt. %, based on the weight of the composition, of the toughening agent.

### Core Shell Rubber (CSR) Particles (Solid Toughening Agent)

The adhesive compositions may also contain core shell rubber (CSR) particles, optionally dispersed in an epoxy resin. See, e.g., U.S. Pat. No. 8,673,108 which is incorporated herein by reference. Core shell rubber (CSR) particles generally have a core comprised of a polymeric material having elastomeric or rubbery properties (i.e., a glass transition temperature less than about 0° C., e.g., less than about −30° C.) surrounded by a shell comprised of a non-elastomeric polymeric material (i.e., a thermoplastic or thermoset/crosslinked polymer having a glass transition temperature greater than ambient temperatures, e.g., greater than about 50° C.), as measured by differential scanning calorimetry (DSC). The rubber core may constitute about 50 to about 90%, or such as about 50 to about 85% of the weight of the core-shell rubber particle.

In some embodiments, the CSR particles have an average particle size less than about 500 nm. In still other embodiments, the CSR particles have an average particle size greater than about 500 nm, e.g., average particle size may be about 0.03 to about 2 microns or about 0.05 to about 1 micron. Desirably, the rubber particles have an average diameter of less than about 500 nm. In other embodiments, the average particle size is less than about 200 nm. For example, the rubber particles may have an average diameter within the range of from about 25 to about 200 nm or about 50 to about 150 nm. The core-shell rubber particles may have a number average particle size (diameter) of about 10 to about 300 nanometers, or such as about 75 to about 250 nanometers, as determined by transmission electron spectroscopy, i.e., “nano core shell rubber particles”.

The core may be comprised of a diene homopolymer or copolymer of monomers comprising one or more of butadiene, isoprene, ethylenically unsaturated monomers such as vinyl aromatic monomers, (meth)acrylonitrile, (meth)acrylates, or the like, or such as polybutadiene cored particles. Other suitable rubbery core polymers may include polybutylacrylate or polysiloxane elastomer (e.g., polydimethylsiloxane).

The shell may be comprised of a polymer or copolymer of one or more monomers such as (meth)acrylates (e.g., methyl methacrylate), vinyl aromatic monomers (e.g., styrene), vinyl cyanides (e.g., acrylonitrile), unsaturated acids and anhydrides (e.g., acrylic acid), (meth)acrylamides, and the like having a suitably high glass transition temperature; or such as acrylates, in particular, poly(methylmethacrylates). The shell polymer or copolymer may be crosslinked and/or have one or more different types of functional groups (e.g., carboxylic acid or epoxy groups) that are capable of interacting with other components of the adhesive. In one embodiment, the shell polymer may be polymerized from at least one lower alkyl methacrylate such as methyl-, ethyl- or t-butyl methacrylate. Up to 40 wt. % of the shell polymer can be formed from other monovinylidene monomers such as styrene, vinyl acetate, and vinyl chloride, methyl acrylate, ethyl acrylate, butyl acrylate, and the like. The shell polymer may be a homopolymer of any of such lower alkyl methacrylate monomers. The molecular weight (Mn) of the grafted shell polymer may be generally between 20,000 and 500.000. The rubber particle may be comprised of more than two layers (e.g., a central core rubbery material may be surrounded by a different rubbery material then shell or two shells or hard shell, soft shell, hard shell). The shell may be grafted onto the core.

CSR particles may be prepared as a masterbatch where the rubber particles are dispersed in one or more epoxy resins such as a diglycidyl ether of bisphenol A, optionally remaining as separated individual particles with little or no agglomeration of the particles or precipitation (settling) of the particles as the masterbatch is aged by standing at room temperature. The core-shell rubber particles may be provided as a dispersion in an epoxy or a phenolic resin matrix. Such a dispersion may contain. e.g., about 5 to about 50 wt. % (about 15 to about 40 wt. %) of the core-shell rubbers, with the remainder being the epoxy resin. The epoxy resin in such a dispersion may be a polyglycidyl polyphenol ether as described above. The matrix material may be liquid at room temperature. Examples of epoxy matrices include the diglycidyl ethers of bisphenol A, F or S, or bisphenol, novolac epoxies, and cycloaliphatic epoxies. Examples of phenolic resins include bisphenol-A based phenoxies. Commercially available as dispersions of rubber particles having a core-shell structure in an epoxy resin matrix are those available from Kaneka Corporation under the tradename “ACE MX” described as having a polybutadiene core or a copolymer core of (meth)acrylate-butadiene-styrene, where butadiene is the primary component in phase separated particles, dispersed in epoxy resins. When the core-shell rubber particles are provided in the form of such a dispersion, only the weight of the core-shell rubber particles is counted toward the core-shell rubber component of this disclosure. Methods of making masterbatches are described EP 1632533. U.S. Pat. Nos. 4,778,851 and 6,111,015, each incorporated herein by reference in its entirety.

Examples of CSR particles suitable for use in the present compositions include those commercially available from: Rohm & Haas under the tradename PARALOID EXL 2600/3600 series, described as styrene/methylmethacrylate copolymer grafted onto a polybutadiene core, average particle size of 0.1-0.3 microns; Roehm GmbH or Roehm America, Inc. under the tradename DEGALAN; Nippon Zeon under the tradename F351; in powder form from Wacker Chemie under the tradename GENIOPERL, described by the supplier as having crosslinked polysiloxane cores, epoxy-functionalized polymethylmethacrylate shells, polysiloxane content of about 65 wt. %; and Kaneka Kane Ace MX-153. MX-154, MX-257 and MX-EXP-EH2 (Kane Ace MX-160).

Combinations of different core-shell rubber particles may advantageously be used in the present invention. The core-shell rubber particles may differ, e.g., in particle size, the glass transition temperatures of their respective cores and/or shells, the compositions of the polymers used in their respective cores and/or shells, the functionalization of their respective shells, and so forth. A portion of the core-shell particles may be supplied to the adhesive composition in the form of a masterbatch wherein the particles are stably dispersed in an epoxy resin matrix and another portion may be supplied to the adhesive composition in the form of a dry powder (i.e., without any epoxy resin or other matrix material). For example, the adhesive composition may be prepared using both a first type of core-shell particles in dry powder form having an average particle diameter of about 0.1 to about 0.5 microns and a second type of core-shell particles stably dispersed in a matrix of liquid bisphenol A diglycidyl ether at a concentration of about 5 to about 50 wt. % having an average particle diameter of about 25 to about 200 nm. The weight ratio of first type: second type core-shell rubber particles may be, e.g., about 1.5:1 to about 0.3:1.

Alternatively or with the CSR, the compositions may comprise rubber particles that do not have shells that encapsulate a central core. In such embodiments, the chemical composition of the rubber particles may be essentially uniform throughout each particle or may have its outer surface modified by irradiation or chemical processing to aid in dispersion in the matrix or adhesion thereto. The polymers suitable for use in preparing rubber particles that do not have shells may be selected from any of the types of polymers previously described as suitable for use as the core of core-shell rubber particles. The polymer may contain functional groups such as carboxylate groups, hydroxyl groups or the like and may have a linear, branched, crosslinked, random copolymer or block copolymer structure. Exemplary commercially available rubber particles include acrylonitrile butadiene copolymer, butadiene/styrene/2-vinylpyridine copolymer; hydroxy-terminated polydimethylsiloxane; and similar elastomeric solid rubbers. These particles may optionally be surface modified to create polar groups (carboxylic acid or hydroxyl groups) and/or doped with minor amounts of inorganic materials such as calcium carbonate of silica, as is known in the art. When the rubber particles do not have a core-shell structure, desirably the rubber particles have an average diameter of less than about 750 nm, 500 nm, or 200 nm. For example, the rubber particles may have an average diameter ranging about 25 to about 200 nm or about 50 to about 150 nm.

In the adhesive composition, in some embodiments, the core shell rubber (CSR) particles may be characterized by one or more of the following features: (a) the CSR particles are monomodally or bimodally dispersed, allowing for maximum concentrations; the dispersity of the CSR particles may be defined by any suitable means including sedimentation of visual or automated of transmission electron microscopy (TEM) images; (b) the CSR particles have a mean particle size of about 50 nm, about 75 nm, about 100 nm, about 125 nm, about 150 nm, about 175 nm, about 200 nm, about 250 nm, or 500 nm, or in a range bounded by any two of the foregoing values; in still another embodiment, the rubber particles have a core-shell structure and an average particle size greater than about $00 nm; (c) the CSR particles have a core comprising, consisting essentially of, or consisting of polybutadiene, a butadiene/styrene copolymer, or an acrylic polymer or copolymer; and/or (d) the CSR particles are dispersed in DGEBA epoxy resin.

In the disclosed compositions, use of these core shell rubbers allows for toughening to occur in the formulation, irrespective of the temperature or temperatures used to cure the formulation. In addition, predictable toughening—in terms of temperature neutrality toward cure—may be achieved because of the substantially uniform dispersion.

The adhesive compositions contain about 1 to about 25 wt. % of the CSR particles. In some embodiments, the adhesive compositions contain about 1, about 5, about 10, about 15, about 20, or about 25 wt. %, based on the weight of the composition, of CSR particles. In other embodiments, the adhesive compositions contain about 1 to about 20, about 1 to about 15, about 1 to about 10, about 1 to about 5, about 5 to about 25, about 5 to about 20, about 5 to about 15, about $ to about 10, about 10 to about 25, about 10 to about 20, about 10 to about 15, about 15 to about 25, about 15 to about 20, or about 20 to about 25 wt. %, based on the weight of the composition, of the CSR particles. In further embodiments, the adhesive compositions contain about 10 to about 20 wt. %, based on the weight of the composition, of CSR particles. In yet other embodiments, the adhesive compositions contain about 20 to about 25 wt. %, based on the weight of the composition, of CSR particles.

Alternatively, or in addition, the adhesive compositions may contain about 1 to about 50 wt. % of CSR particles dispersed in DGEBA (with an about 40% or about 45% CSR content). In some embodiments, the adhesive compositions contain about 1, about 10, about 20, about 30, about 40, or about 50 wt. %, based on the weight of the composition, of CSR particles dispersed in DGEBA. In other embodiments, the adhesive compositions contain about 1 to about 50, about 1 to about 40, about 1 to about 30, about 1 to about 20, about 1 to about 10, about 10 to about 50, about 10 to about 40, about 10 to about 30, about 10 to about 20, about 20 to about 50, about 20 to about 40, about 20 to about 30, about 30 to about 50, about 30 to about 40, or about 40 to about 50 wt. %, based on the weight of the composition, of CSR particles dispersed in DGEBA. In further embodiments, the adhesive compositions contain about 25 to about 44 wt. %, based on the weight of the composition, of CSR particles dispersed in DGEBA. In yet other embodiments, the adhesive compositions contain about 20 to about 25 wt. %, based on the weight of the composition, of CSR particles.

In further embodiments, the core shell rubber (CSR) particles (a) are identifiable as monomodally or bimodally dispersed; (b) have a mean particle size of about 50 nm, about 75 nm, about 100 nm, about 125 nm, about 150 nm, about 175 am, about 200 nm, about 250 nm, or about 500 nm, or in a range bounded by any two of the foregoing values; (c) have a core comprising, consisting essentially of, or consisting of polybutadiene, a butadiene/styrene copolymer, or an acrylic polymer or copolymer; and/or (d) are dispersed in DGEBA epoxy resin.

### Polyurethane Toughening Agents

As discussed above, the adhesive composition described herein also contains at least one toughening agent, which may be based on polyurethane prepolymers, in some instances in the absence of CTBN & CSR. In some embodiments, systems using polyurethane prepolymer toughening components use total toughening agent in amounts of 15-25 wt. %. In other embodiments, the toughening agent comprises one or more polyurethane pre-polymers based on (poly(tetramethylene ether)glycol and/or polybutadiene, which may be end-capped.

In some embodiments, the polyurethane toughening agent may also provide flexibility based on polyalkylene glycol portions of the agent. See for example, according to U.S. Pat. No. 8,673,108, which is incorporated herein by reference.

In certain embodiments, the polyurethane toughening agent comprises a polyalkylene glycol segment. In some embodiments, the polyalkylene glycol segment independently comprises a polyethylene glycol, a polypropylene glycol, or a polybutylene glycol (alternatively a polytetramethylene glycol (poly-THE or PTMEG), having an equivalent molecular weight in a range of about 2000 to about 5000 Daltons or such as about 1000 to about 2000 Daltons. PTMEG linkages are preferred. In other embodiments, the polyurethane toughening agent also contains polyalkylene (extender) segments, or such as where the polyalkylene glycol segment is flanked by end-capped C₁₋₁₀ alkylene linkages, or such as C₆₋₈ alkylene linkages and coupled thereto by urethane groups.

In other embodiments, the polyurethane toughening agent comprises elastomeric tougheners comprising capped isocyanate groups. See, for example those disclosed in, incorporated by reference publications: U.S. Pat. Nos. 5,202,390; 5,278,257; WO-2005/118734; WO-2007/003650; WO-2012/091842, US-2005/0070634; US-2005/0209401; US-2006/0276601; EP-0,308,664, EP-1,498,441; EP-1,728,825; EP-1,896,517; EP-1,916,269; EP-1,916,270; EP-1,916,272 and EP-1,916,285. These elastomeric tougheners are products of the reaction of an amine- or hydroxyl-terminated rubber with a polyisocyanate to form an isocyanate-terminated prepolymer, optionally chain-extending the prepolymer, followed by capping the isocyanate groups with a capping group such as, e.g., a) aliphatic, aromatic, cycloaliphatic, araliphatic and/or heteroaromatic monoamines that have one primary or secondary amino group; b) phenolic compounds, including monophenols, polyphenols and aminophenols: c) benzyl alcohol, which may be substituted with one or more alkyl groups on the aromatic ring; d) hydroxy-functional acrylate or methacrylate compounds: e) thiol compounds such as alkylthiols having 6 to 16, carbon atoms in the alkyl group, including dodecanethiol; f) alkyl amide compounds having at least one amine hydrogen such as acetamide and N-alkylacetamide; and g) a ketoxime.

In further embodiments, the one or more blocked polyurethane toughening agents may be end-capped at both ends of the structure. The two end-capping groups of the blocked polyurethane toughening agent may be the same or different.

In yet other embodiments, Huntsman's DY 965 is one commercially available example of suitable blocked polyurethane toughening agent, in which both end-caps comprise bisphenol such as O,O′-diallyl-bisphenol-A. While in some cases, end-capping by one or more bisphenol, other end-capping agents include optionally substituted phenols (or hydroxyheteroaryl analogs), amines, methacryl, acetoxy, oximes, and/or pyrazoles. See, e.g., Johannes Karl Fink, in High Performance Polymers (Second Edition), 2014.

In still further embodiments, the blocked polyurethane toughening agent has at least one end cap derived from methylethylketone oxime, 2,4-dimethyl-3-pentanone oxime or 2,6-dimethyl-4-heptanone oxime, diethyl malonate, 3,5-dimethylpyrazole, 1,2,4-triazole, or mixtures of diisopropylamine and 1,2,4-triazole, or combinations thereof. End-cap substituents that are hydrophobic also appear to ensure additional benefits, including e.g. C₁₂₋₂₄ pendant functional groups comprising 1, 2, 3, or 4 conjugated and/or non-conjugated alkenylene bonds. Accordingly, in separate embodiments, the optional substituents of the phenols (or hydroxyheteroaryl analogs), amines, methacryl, acetoxy, oximes, and/or pyrazoles comprise such pendant functional groups. In other embodiments, the flanking C₁₋₁₀ alkylene linkages may be end-capped by at least one monophenol comprising at least one C₁₂₋₂₄ pendant functional groups, the at least one C₁₂₋₂₄ pendant functional groups containing 1, 2, 3, or 4 conjugated and/or non-conjugated alkenylene bonds. Again, the use of substituted monophenols, relative to bis-phenol is preferred in that they appear to provide a lower curing temperature than the bisphenol end-caps. In some embodiments, the polyurethane toughening agent may be a phenol polyurethane adduct.

In a preferred embodiment, the polyurethane toughening agent comprised one or more of a bisphenol terminated polyurethane pre-polymer having a MW of about 10-20K Daltons, a polyurethane pre-polymer end-capped asymmetrically with an oxime and a hydrophobic mono-phenolic functional groups and having a MW of about 10000 Daltons, a polyurethane pre-polymer having a MW of about 2000, end-capped with hydrophobic mono-phenolic functional groups.

The adhesive compositions contain about 0.1 to about 34 wt. %, based on the weight of the composition, of a polyurethane toughening agent. In some embodiments, the adhesive compositions contain about 0.1, about 0.5, about 1, about 2, about 5, about 10, about 15, about 20, about 25, about 30, or about 34 wt. %, based on the weight of the composition, of the polyurethane toughening agent. In other embodiments, the adhesive composition contains about 0.1 to about 30, about 0.1 to about 25, about 0.1 to about 20, about 0.1 to about 15, about 0.1 to about 10, about 0.1 to about 5, about 0.1 to about 1, about 1 to about 34, about 1 to about 30, about 1 to about 25, about 1 to about 20, about 1 to about 15, about 1 to about 10, about 1 to about 5, about 5 to about 34, about 5 to about 30, about 5 to about 25, about 5 to about 20, about 5 to about 15, about 5 to about 10, about 10 to about 34, about 10 to about 30, about 10 to about 25, about 10 to about 20, about 10 to about 15, about 15 to about 34, about 15 to about 30, about 15 to about 25, about 15 to about 20, about 20 to about 34, about 20 to about 30, about 20 to about 25, about 25 to about 34, about 25 to about 30, or about 30 to about 34 wt. %, based on the weight of the composition, of the polyurethane toughening agent. In further embodiments, the adhesive composition contains about 2 to about 30 wt. %, based on the weight of the composition, of the polyurethane toughening agent. In yet other embodiments, the adhesive composition contains about 2 to about 30 wt. %, based on the weight of the composition, of the polyurethane toughening agent. In still further embodiments, the adhesive composition contains about 5 to about 20 wt. %, based on the weight of the composition, of the polyurethane toughening agent. In other embodiments, the adhesive composition contains about 8 to about 12 wt. %, based on the weight of the composition, of the polyurethane toughening agent.

### F. Optional Flexibilizer

In some embodiments, the adhesive composition may contain one or more flexibilizers. The flexibilizer may be selected by one skilled in the art. For example, the flexibilizer may be a polyetheramine-DGEBA adduct. The polyetheramine may be an end-capped polypropylene glycol characterized by repeating oxypropylene units in the backbone in sufficient number to provide an average weight averaged molecular weight in a range of about 1000 to about 3000 Daltons, such as about 2000 Daltons. Such materials are commercially available from Huntsman as Jeffamine® polyetheramines. Other examples of flexibilizers include, without limitation, dimer fatty acids; dimer fatty acid-epoxy (DGEBA) adducts; epoxy diluents, different from “A. Epoxy Resin” having aliphatic; di and tri-functionality; and solid epoxy resins.

The adhesive compositions may contain about 0.1 to about 14 wt. %, based on the weight of the composition, of a flexibilizer. In some embodiments, the adhesive compositions contain about 0.1, about 0.5, about 1, about 2, about 3, about 4, about 5, about 6, about 7, about 8, about 9, about 10, about 11, or about 12 wt. %, based on the weight of the composition, of the flexibilizer. In other embodiments, the adhesive compositions contain about 0.1 to about 10, about 0.1 to about 8, about 0.1 to about 6, about 0.1 to about 4, about 0.1 to about 2, about 0.1 to about 1, about 0.5 to about 10, about 0.5 to about 8, about 0.5 to about 6, about 0.5 to about 4, about 0.5 to about 2, about 0.5 to about 1, about 1 to about 10, about 1 to about 8, about 1 to about 6, about 1 to about 4, about 1 to about 2, about 2 to about 10, about 2 to about 8, about 2 to about 6, about 2 to about 4, about 4 to about 10, about 4 to about 8, about 4 to about 6, about 6 to about 10, about 6 to about 8, or about 8 to about 10 wt. %, based on the weight of the composition, of a flexibilizer.

### G. Optional Adhesion Promoter Phosphate

According to the disclosure, the adhesive compositions may further comprise adhesion promoter. In certain embodiments, the adhesion promoter also may be a flame retardant. In certain embodiments, the flame retardant is or comprises one or more of ammonium polyphosphates, melamine, melamine polyphosphate, a phosphonate ester (e.g., diethyl bis(hydroxyethyl) aminomethyl phosphonate (commercially available as Fyrol® 6 phosphonate ester), a halogen-free phosphorus ester (commercially available as Fyrol® HF-9), or any combination.

One example of a suitable adhesion promotor is a phosphorus adhesion promoter. In some embodiments, the phosphorus adhesion promoter comprises a substituted or unsubstituted triphenyl phosphate. In certain aspects, the phosphorus adhesion promoter may be unsubstituted triphenyl phosphate. In further aspects, the phosphorus adhesion promoter may be substituted triphenyl phosphate. In other embodiments, the phosphorus adhesion promoter comprises at least one tris(alkylphenyl)phosphate, wherein the alkyl contains 1-10 carbon atoms, i.e., C₁₋₁₀alkyl. Examples include unsubstituted, mono-, di-, and/or tri-butylated phenyl phosphates, e.g., Emerald Innovation NHI. In further embodiments, the phosphorus adhesion promoter comprises one or more of tris(4-isopropylphenyl) phosphate, tris(3-isopropylphenyl) phosphate, tris[4-(2-methylpropyl)phenyl] phosphate, or triphenyl phosphate. In yet other embodiments, the phosphorus adhesion promoter may be tris(4-isopropylphenyl) phosphate. In still further embodiments, the phosphorus adhesion promoter may be tris[4-(2-methylpropyl)phenyl]phosphate. In other embodiments, the phosphorus adhesion promoter may be triphenyl phosphate.

The adhesive composition contains about 0.5 to about 5 wt. %, based on the weight of the composition, of the phosphorus adhesion promoter. In some embodiments, the adhesive composition contains about 0.5, about 1, about 2, about 3, about 4, or about 5 wt. %, based on the weight of the composition, of the phosphorus adhesion promoter. In other embodiments, the adhesive composition contains about 0.5 to about 4, about 0.5 to about 3, about 0.5 to about 2, about 0.5 to about 1, about 1 to about 55, about 1 to about 4, about 1 to about 3, about 1 to about 2, about 2 to about 5, about 2 to about 4, about 2 to about 3, about 3 to about 5, about 3 to about 4, or about 4 to about 5 wt. %, based on the weight of the composition, of the phosphorus adhesion promoter. In further embodiments, the adhesive composition contains about 2 to about 3 wt. %, based on the weight of the composition, of the phosphorus adhesion promoter.

### H. Optional Adhesion Promoter Silane

Another example of an adhesion promoter is a silane adhesion promoter. In some embodiments, the silane adhesion promoter may be 3-glycidyloxypropyltrimethoxy silane (GLYMO). In some embodiments, the adhesive composition contains about 0.1 to about 0.3 wt. %, based on the weight of the composition, of the silane adhesion promoter. In other embodiments, the adhesive composition contains about 0.1, about 0.2 or about 0.3 wt. %, based on the weight of the composition, of the silane adhesive promoter. In further embodiments, the adhesive composition contains about 0.1 to about 0.2 or about 0.2 to about 3 wt. %, based on the weight of the composition, of the silane adhesion promoter. In yet other embodiments, the adhesive composition contains 0.1 to about 0.2 wt. %, based on the weight of the composition, of the silane adhesion promoter.

### I. Optional Filler

According to the disclosure, the adhesive composition may contain a filler. Examples of fillers include organic, inorganic and combinations thereof, that may provide structural integrity to the compositions prior to curing. In some embodiments, the filler is an inorganic filler. In certain embodiments, one or more fillers may be present and may comprise one or more of calcium carbonate, calcium oxide, calcium silicate, aluminosilicate, organophilic phyllosilicates, naturally occurring clays such as bentonite, wollastonite or kaolin glass, silica, mica, tale, microspheres, or hollow glass microspheres (HGM), chopped or milled fibers (e.g., carbon, glass, or aramid), pigments, zeolites (natural or synthetic), or thermoplastic fillers. While some embodiments may comprise a single filler, typically a plurality of different fillers may be present, e.g. 2, 3, 4 or 5 different fillers distinguished for example by composition, size, shape, aspect ratio (L/D) and the like. In some embodiments, a filler may have a low aspect ratio (e.g., less than about 1) or a high aspect ratio (e.g., chopped or milled fibers).

The adhesive compositions contain about 1 to about 35 wt. %, based on the weight of the composition, of the, preferably inorganic, filler. In some embodiments, the adhesive composition contains about 1, about 5, about 10, about 12, about 13, about 14, about 15, about 16, about 17, about 18, about 20, about 25, about 30, or about 35 wt. %, based on the weight of the composition, of the filler. In other embodiments, the adhesive composition contains about 1 to about 30, about 1 to about 25, about 1 to about 20, about 1 to about 15, about 1 to about 10, about 1 to about 5, about 5 to about 35, about 5 to about 30, about 5 to about 25, about 5 to about 20, about 5 to about 15, about 5 to about 10, about 10 to about 35, about 10 to about 30, about 10 to about 25, about 10 to about 20, about 10 to about 15, about 12 to about 35, about 12 to about 30, about 12 to about 25, about 12 to about 20, about 12 to about 18, about 12 to about 16, about 12 to about 14, about 14 to about 35, about 14 to about 30, about 14 to about 25, about 14 to about 20, about 14 to about 18, about 14 to about 16, about 16 to about 35, about 16 to about 30, about 16 to about 25, about 16 to about 20, about 16 to about 18, about 18 to about 35, about 18 to about 30, about 18 to about 25, about 18 to about 20, about 20 to about 35, about 20 to about 30, about 20 to about 25, about 25 to about 35, about 25 to about 30, or about 30 to about 35 wt. %, based on the weight of the composition, of the filler. In further embodiments, the adhesive composition contains about 12 to about 18 wt. %, based on the weight of the composition, of the filler. In still other embodiments, the adhesive composition contains about 4 to about 6 wt. %, based on the weight of the composition, of the filler.

Examples of inorganic fillers include, without limitation, a desiccant, thixotrope, or a combination thereof. In some embodiments, the inorganic filler may be or comprise calcium oxide, calcium metasilicate, mica, mixed mineral thixotrope, hydrophobic surface treated fumed silica, hollow glass microspheres, or a combination thereof.

In some embodiments, the inorganic filler comprises calcium oxide. The adhesive composition may contain about 1 to about 10 wt. %, based on the weight of the composition, of calcium oxide. In certain aspects, the adhesive composition contains about 1, about 2, about 3, about 4, about 5, about 6, about 7, about 8, about 9, or about 10 wt. % of calcium oxide. In other aspects, the adhesive compositions contain about 1 to about 8, about 1 to about 6, about 1 to about 4, about 1 to about 2, about 2 to about 10, about 2 to about 8, about 2 to about 6, about 2 to about 4, about 4 to about 10, about 4 to about 8, about 4 to about 6, about 6 to about 10, about 6 to about 8, or about 8 to about 10) wt. %, based on the weight of the composition, of calcium oxide. In further aspects, the adhesive compositions contain about 4 to about 6 wt. %, based on the weight of the composition, of calcium oxide.

In other embodiments, the inorganic filler comprises calcium metasilicate. Examples of calcium metasilicates include, without limitation, Nyad 400M. In certain aspects, the adhesive compositions contain about 1 to about 10 wt. %, based on the weight of the composition, of calcium metasilicate. In other aspects, the adhesive compositions contain about 1, about 2, about 3, about 4, about 5, about 6, about 7, about 8, about 9, or about 10 wt. %, based on the weight of the composition, of calcium metasilicate. In other aspects, the adhesive compositions contain about 1 to about 8, about 1 to about 6, about 1 to about 4, about 1 to about 2, about 2 to about 10, about 2 to about 8, about 2 to about 6, about 2 to about 4, about 4 to about 10, about 4 to about 8, about 4 to about 6, about 6 to about 10, about 6 to about 8, or about & to about 10 wt. %, based on the weight of the composition, of calcium metasilicate. In further aspects, the adhesive compositions contain about 4 to about 6 wt. %, based on the weight of the composition, of calcium metasilicate.

In further embodiments, the inorganic filler comprises mica. Examples of micas include, without limitation, WG 325. In certain aspects, the adhesive compositions contain about 0.1, about 0.2, about 0.3, about 0.4, about 0.5, about 0.6, about 0.7, about 0.8, about 0.9, or about 1 wt. %, based on the weight of the composition, of mica. In other aspects, the adhesive compositions contain about 0.1 to about 0.8, about 0.1 to about 0.6, about 0.1 to about 0.4, about 0.1 to about 0.2, about 0.2 to about 1, about 0.2 to about 0.8, about 0.2 to about 0.6, about 0.2 to about 0.4, about 0.2 to about 0.3, about 0.4 to about 1, about 0.4 to about 0.8, about 0.4 to about 0.6, about 0.6 to about 1, about 0.6 to about 0.8, or about 0.8 to about 1 wt. %, based on the weight of the composition, of mica. In further aspects, the adhesive compositions contain about 0.2 to about 0.3 wt. %, based on the weight of the composition, of mica.

In yet other embodiments, the inorganic filler comprises a mixed mineral thixotrope. In certain aspects, the adhesive compositions contain about 0.1, about 0.2, about 0.3, about 0.4, about 0.5, about 0.6, about 0.7, about 0.8, about 0.9, or about 1 wt. %, based on the weight of the composition, of mixed mineral thixotrope. Examples of mixed mineral thixotropes include, without limitation, Garamite® products including Garamite® 7305 or Garamite® 1958. In other aspects, the adhesive compositions contain about 0.1 to about 0.8, about 0.1 to about 0.6, about 0.1 to about 0.4, about 0.1 to about 0.2, about 0.2 to about 1, about 0.2 to about 0.8, about 0.2 to about 0.6, about 0.2 to about 0.4, about 0.2 to about 0.3, about 0.4 to about 1, about 0.4 to about 0.8, about 0.4 to about 0.6, about 0.6 to about 1, about 0.6 to about 0.8, or about 0.8 to about 1 wt. %, based on the weight of the composition, of mixed mineral thixotrope. In further aspects, the adhesive compositions contain about 0.3 to about 0.6 wt. %, based on the weight of the composition, of mixed mineral thixotrope.

In still further embodiments, the inorganic filler comprises a fumed silica, such as a hydrophobic surface treated fumed silica. Examples of hydrophobic surface treated fumed silica include, without limitation, those commercially available under the tradename CAB-O-SIL as well as hydrophobic fumed silicas such as polydimethylsiloxane (PDMS) treated fumed silica. In certain aspects, the adhesive composition contains about 1 to about 8 wt. %, based on the weight of the composition, of hydrophobic surface treated fumed silica. In other aspects, the adhesive composition contains about 1, about 2, about 3, about 4, about 5, about 6, about 7, or about 8 wt. %, based on the weight of the composition, of a hydrophobic surface treated fumed silica. In further aspects, the adhesive composition contains about 1 to about 8, about 1 to about 6, about 1 to about 4, about 1 to about 2, about 2 to about 10, about 2 to about 8, about 2 to about 6, about 2 to about 4, about 3 to about 9, about 3 to about 7, about 3 to about 5, about 4 to about 10, about 4 to about 8, about 4 to about 6, about 6 to about 10, about 6 to about &, or about 8 to about 10 wt. %, based on the weight of the composition, of a hydrophobic surface treated fumed silica. In further aspects, the adhesive composition contains about 3 to about 4 wt. %, based on the weight of the composition, of the hydrophobic surface treated fumed silica. In yet other aspects, the adhesive composition contains about 4 wt. %, based on the weight of the composition, of the hydrophobic surface treated fumed silica. In still further aspects, the adhesive composition contains about 3.4 wt. %, based on the weight of the composition, of the hydrophobic surface treated fumed silica.

In other embodiments, the inorganic filler comprises glass microspheres, such as hollow glass microspheres, which are commercially available and well known in the art. In certain aspects, the adhesive compositions contain about 0.5 to about 3 wt. %, based on the weight of the composition, of hollow glass microspheres. In other aspects, the compositions contain about 0.5, about 0.6, about 0.7, about 0.8, about 0.9, about 1, about 1.5, about 2, about 2.5, or about 3 wt. %, based on the weight of the composition, of hollow glass microspheres. In further aspects, the adhesive compositions contain about 0.5 to about 2.5, about 0.5 to about 2, about 0.5 to about 1.5, about 0.5 to about 1, about 0.5 to about 0.8, about 0.5 to about 0.6, about 0.6 to about 3, about 0.6 to about 2.5, about 0.6 to about 2, about 0.6 to about 1.6, about 0.6 to about 1, about 0.6 to about 0.8, about 0.8 to about 3, about 0.8 to about 2.5, about 0.8 to about 2, about 0.8 to about 1.5, about 0.8 to about 1, about 1 to about 3, about 1 to about 2.5, about 1 to about 2, about 1 to about 1.5, about 1.5 to about 3, about 1.5 to about 2.5, about 1.5 to about 2, about 2 to about 3, about 2 to about 2.5, or about 2.5 to about 3 wt. %, based on the weight of the composition, of hollow glass microspheres. In yet other aspects, the adhesive compositions contain about 0.6 to about 1 wt. %, based on the weight of the composition, of hollow glass microspheres.

### J. Optional Additional Epoxy Resin(s)

The adhesive compositions of the disclosure may contain one or more additional epoxy resins that differ from the epoxy resin described above as “A. Epoxy Resin”. In some embodiments, the adhesive composition contains one “Additional Epoxy Resin J.”. In other embodiments, the adhesive composition contains a plurality of additional epoxy resins, for example in further embodiments, the adhesive composition may contain 2, 3, 4 or more “Additional Epoxy Resin J.”

In some embodiments, the additional epoxy resin may be a phenol novolac epoxy. Such multifunctional epoxy resins may be manufactured from phenol novolac resin and epichlorohydrin. When cured, they form cured materials that possess a mesh structure with a high cross-linking density. They also demonstrate excellent performance in heat and chemical resistance. In the liquid epoxy adhesive compositions described herein, when present the phenol novolac epoxies desirably have an EEW in a range of about 165 to about 185, or about 172 to about 179. Suitable epoxy novolac resins include those sold under the tradename D.E.N.®, including the 300 and 400 series epoxy novolac resins, commercially available from Olin Corporation.

### K. Other Optional Components

The adhesive compositions may also optionally comprise additional components, e.g., additives. Examples of additives include plasticizers such as tricresyl phosphate and the like; diluents, e.g., epoxy compatible chemically inert hydrocarbon resin; extenders; colorant, e.g. pigments (which may also act as filler) and dyes; coupling agents, e.g., silane coupling agents, such as a gamma-glycidoxypropyltrimethoxysilane coupling agent; expanding agents; blowing agents; flow control agents, and antioxidants.

### Methods of Preparing the Adhesive Compositions

Methods of making the adhesive composition are set forth herein. In certain of these embodiments, the methods comprise combining the corresponding components at a temperature less than the activation energy of the final desired composition. In certain embodiments, this temperature may be in a range of about 20° C. to about 40° C., about 40° C. to about 60° C., about 60° C. to about 80° C., or any combination of two or more of the foregoing ranges.

It is generally most convenient to pre-mix those components that exist as liquids at ambient temperatures before adding those components that exists as solids at ambient temperature, but the order of mixing is not believed to be critical. In one embodiment, the curative package, e.g. DICY, urea and latent reactant are added in a final step.

### Methods of Using the Adhesive Compositions

The epoxy adhesive compositions described herein are useful in transportation industries, such as aerospace, automotive, marine, and construction vehicle manufacture using heat curing methods. In a preferred embodiment, epoxy adhesive compositions may be used in vehicle parts or components where impact resistance is desirable. For example, methods of forming structural bonds may comprise forming bonds between surfaces where the bond may be subjected to shear forces, peel forces and wedge impacts measured by those of skill in the art using lap shear strength testing according to ASTM D1002; peel resistance measured using T-peel strength conditions of ASTM D1876-08(2015)e1, and resistance to cleavage fracture measured using the wedge impact method of ISO 11343.2019 and comparable performance testing. The surfaces to be bonded may be metal surfaces, composite materials parts or a combination thereof. For example, in vehicle construction, methods include bonding such as at metal-to-metal interfaces such as in hem flanges and in body panel joining, e.g. using weld bonding, a process that combines spot welding and adhesive bonding. The uses of the adhesive compositions in forming a bonding surface comprising a corresponding cured epoxy adhesive layer are considered independent embodiments of the present disclosure, as are the methods of using them for this purpose.

The adhesive compositions can be applied to substrates by any convenient technique. Desirably the compositions are pumpable and can be applied at ambient temperature or be applied warm if desired, such as heating only up to a temperature at which the latent curing agent is not yet activated. Adhesive can be applied manually and/or robotically, using, e.g., jet spraying methods or extrusion apparatus. The compositions can be applied by extrusion from a robot in bead form or by mechanical or manual application means and can also be applied using a swirl or streaming technique. The swirl and Streaming techniques utilize equipment well known in the art such as pumps, control systems, dosing guns, remote dosing devices and application guns. The adhesive composition may be applied to one or both of the substrates to be joined. Once the adhesive composition is applied, the substrates are contacted such that the adhesive is located at a bond line between the substrates. The substrates are contacted such that the adhesive is located between the substrates to be bonded together. Thereafter, the adhesive composition is subjected to heating to a temperature at which the heat curable or latent curing agent initiates cure of the epoxy resin composition forming a bonded assembly comprising the cured epoxy adhesive located between the substrates and adhered thereto.

In some embodiments, the adhesive composition may be formulated to function as a hot melt; that is, an adhesive which is solid at room temperature, but capable of being converted to a pumpable or flowable material when heated to a temperature above room temperature. In another embodiment, the composition of this invention may be formulated to be capable of being flowed or pumped to the work site at ambient temperatures or slightly above since, in most applications, it is preferable to ensure that the adhesive is heated only up to a temperature at which the latent curing agent is not yet activated. The melted composition may be applied directly to the substrate surface or may be allowed to flow into a space separately the substrates to be joined, such as in a hem flanging operation. In yet another embodiment, the composition is formulated (by inclusion of a finely divided thermoplastic or by use of multiple curatives having different activation temperatures) such that the curing process proceeds in two or more stages (partial curing at a first temperature, complete curing at a second, higher temperature). The two parts are joined together, such as immediately after deposition of the adhesive mass, thereby provisionally bonding the two parts to each other.

The resultant bond may already have sufficient strength so that the still uncured adhesive is not readily washed out, as might otherwise occur, e.g., if the metal sheets which are provisionally bonded to each other are treated for de-greasing purposes in a wash bath and then in a phosphating bath.

The adhesive composition may be finally cured, e.g., at a temperature which lies clearly above the temperature at which the composition was applied to the parts to be bonded and at or above the temperature at which the curing agent and/or accelerator and/or latent expanding agent (if present) are activated (i.e., in the case of the hardener, the minimum temperature at which the curing agent becomes reactive towards the other components of the adhesive; in the case of the expanding agent, the minimum temperature at which the expanding agent causes foaming or expansion of the adhesive). Curing is performed by heating the epoxy adhesive to a temperature of 135° C. or above. In some embodiments, the temperature is about 220° C. or less, such as about 180° C. or less. In other embodiments, the temperature is about 140 to about 150° C. In further embodiments, the temperature is about 140° C. In yet other embodiments, the temperature is about 190° C. The time needed to achieve full cure depends somewhat on temperature, but in general is at least 5 minutes, and more typically is about 15 minutes to about 120 minutes. In certain aspects, the adhesive composition is heated to about 140° C. for about 15 minutes. In other aspects, the adhesive composition is further heated to about 190° C. for about 60 minutes. Curing for extended periods, such as greater than 60, 90 or 120 minutes is not useful in most manufacturing, particularly on assembly lines.

The adhesive composition can be used to bond a variety of substrates together including metal, coated metal, aluminum, a variety of plastic and filled plastic substrates, fiberglass, and the like. The substrates to be joined using the adhesive may be the same as or different from each other. It may be used for the bonding of metal parts and particularly for the bonding of steel sheets such as cold rolled steel sheets. These can also be electro-galvanized, hot-dip galvanized, boron steel, and/or zinc/nickel-coated steel sheets. The adhesive composition also is useful for bonding substrates having surfaces contaminated with oily substances, as good adhesion is attained despite such contamination.

Further possible applications for the adhesive compositions are as fiber-reinforced composite adhesives useful in transportation industries, such as aerospace, automotive, marine, locomotive and construction vehicle manufacture using heat curing methods. The surfaces to be bonded may be metal surfaces, composite materials parts or a combination thereof. One application for the adhesive compositions is the formation of structural bonds in vehicle construction such as in hem flanges and the like.

In other embodiments, the adhesive composition is used to bond parts (e.g., surfaces) of automobiles or other vehicles. Such parts can be steel, coated steel, galvanized steel, aluminum, coated aluminum, plastic and filled plastic substrates. In some embodiments, the part may be steel or aluminum. An application of particular interest is in bonding vehicle frame components to each other or to other components of the vehicle. The frame components are often metals such as cold rolled steel, galvanized metals, or aluminum. The components to be bonded to the frame components can also be metals as just described, or can be other metals, plastics, composite materials, and the like. Assembled automotive frame members are usually coated with a coating material (e.g., paint) that requires a bake cure. The coating is typically baked at temperatures that may range about 140° C. to about 190° C. In such cases, it is often convenient to apply the epoxy adhesive to the frame components, then apply the coating, and cure the epoxy adhesive at the same time the coating is baked and cured. In some embodiments, curing may not be performed immediately after the epoxy adhesive is applied. During such a delay before curing, the epoxy adhesive may be exposed to humid air at a temperature of up to about 40° C.

### Bonded Assemblies Comprising Cured Adhesive Layers

The products disclosed herein include cured adhesive layers that have been prepared by thermally curing the liquid epoxy adhesive compositions set forth herein on a substrate preferably bonding two or more substrates together forming a bonded assembly. In preferred embodiments, the cured adhesive layer has a nominal thickness in a range of about 0.25 to about 0.5 mm nominal, or such as about 0.3-0.4 mm.

The cured adhesive layers are adhered to substrates comprising a cold rolled steel (CRS), an electro galvanized steel (EZG), a hot dip galvanized steel (HDG), or a treated aluminum. The cured adhesive layer shows excellent adhesion to these substrates. In some embodiments, the cured epoxy adhesive layers exhibit a 100% cohesive mode of failure in peel on cold rolled steel (CRS), electro galvanized steel (EZG), hot dip galvanized steel (HDG), and/or treated aluminum when tested under T-peel conditions of ASTM D1876-08(2015)e1 or under the wedge impact method of ISO 11343.2019. These results are attainable without resorting to high concentrations of filler to achieve 100% cohesive mode of failure.

The adhesive compositions described herein exhibit high T-peel strength after exposure to hot wet conditions in the uncured state. The compositions also provide good impact properties at as low as −30° C. or even −40° C., under low and high bake cure conditions. As exemplified in the Examples, the cured epoxy adhesive layers:
(a) having been cured between two 0.8 mm thick cold rolled steel plates at about 140° C. for about 15 min provides adhesion between the plates sufficient to exhibit a T-peel strength of at least about 4, about 5, about 6, about 7, about 8, about 9, about 10, about 11, about 12, about 13, about 14, or about 15 N/mm at room temperature; and/or
(b) having been cured between two 0.8 mm thick cold rolled steel plates at about 190° C. for about 60 min provides adhesion between the plates sufficient to exhibit a T-peel strength of at least about 9, about 10, about 11, about 12, about 13, about 14, or about 15 N/mm at room temperature; and/or
(c) having been cured between two 1.3 mm thick cold rolled steel plates at about 140° C. for about 15 min provides adhesion between the plates sufficient to exhibit a lap shear strength of at least about 10, about 15, about 20, about 25, about 30, about 31, about 32, or about 35 N/mm at room temperature; and/or
(d) having been cured between two 1.3 mm thick cold rolled steel plates at about 190° C. for about 60 min provides adhesion between the plates sufficient to exhibit a T-peel strength of at least about 30, about 31, about 32, about 33, about 34, or about 35 N/mm at room temperature; and/or
(c) having been cured between two 0.8 mm thick cold rolled steel plates at about 140° C. for about 15 min provides adhesion between the plates sufficient to exhibit in impact wedge peel strength of at least about 30, about 31, about 32, about 33, about 34, about 35, about 36, about 37, about 38, about 39, about or 40 N/mm at room temperature; and/or
(f) having been cured between two 0.8 mm thick cold rolled steel plates at about 190° C. for about 60 min provides adhesion between the plates sufficient to exhibit in impact wedge peel strength of at least about 10, about 15, about 20, about 25, or about 30 N/mm at room temperature; and/or
(g) having been cured between two 0.8 mm thick cold rolled steel plates at about 140° C. for about 15 min provides adhesion between the plates sufficient to exhibit in impact wedge peel strength of at least about 9, about 10, about 11, about 12, about 13, about 14, or about 15 N/mm at about-40° C.; and/or
(h) having been cured between two 0.8 mm thick cold rolled steel plates at about 190° C. for about 60 min provides adhesion between the plates sufficient to exhibit in impact wedge peel strength of at least about 15, about 20, about 25, or about 30 N/mm at about −40° C.; and/or

This disclosure embraces all articles of manufacturing comprising any of the liquid (pre- or partially cured) epoxy adhesive composition, as applied thereto (but not fully cured), as well as any cured epoxy adhesive layers adhered thereto. In certain embodiments, the article of manufacturing may be used in transportation industries, such as aerospace, automotive, marine, and construction vehicle manufacture using heat curing methods. In a preferred embodiment, epoxy adhesive compositions may be used in vehicle parts or components where impact resistance is desirable. For example, methods of forming structural bonds may comprise forming bonds between surfaces where the bond may be subjected to shear forces, peel forces and wedge impacts. The surfaces to be bonded may be metal surfaces, composite materials parts or a combination thereof useful for example an automobile or a part thereof.

### Terms and Abbreviations

In the present disclosure the singular forms “a,” “an,” and “the” include the plural reference, and reference to a particular numerical value includes at least that particular value, unless the context clearly indicates otherwise. Thus, e.g., a reference to “a corrosion inhibitor” is a reference to one or more of such corrosion inhibitors and equivalents thereof known to those skilled in the art, and so forth. Furthermore, when indicating that a certain element “may be” X. Y. or Z, it is not intended by such usage to exclude in all instances other choices for the element.

When a value is expressed as an approximation by use of the descriptor “about,” it will be understood that the particular value forms another embodiment. In general, the use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. Where present, all ranges are inclusive and combinable. That is, references to values stated in ranges include every value within that range.

It is to be appreciated that certain features of the disclosure which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is another embodiment. Conversely, various features of the disclosure that are, for brevity, described in the context of a single embodiment, may also be provided separately or in any sub-combination. Finally, while an embodiment may be described as part of a series of steps or part of a more general structure, each said step may also be considered an independent embodiment, combinable with others.

The transitional terms “comprising,” “consisting essentially of,” and “consisting” are intended to connote their generally accepted meanings in the patent lexicon; for those embodiments provided in terms of “consisting essentially of,” the basic and novel characteristic(s) is the facile operability of the methods or compositions/systems to provide compositions as exhibiting the claimed functional features using only those components listed.

When values are expressed as approximations, by use of the antecedent “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. In some embodiments, “about X” (where X is a numerical value) refers to #10% of the recited value, inclusive. For example, the phrase “about 8” can refer to a value of 7.2 to 8.8, inclusive. This value may include “exactly 8”. Where present, all ranges are inclusive and combinable. For example, when a range of “1 to 5” is recited, the recited range should be construed as optionally including ranges “1 to 4”, “1 to 3”, “1-2”, “1-2 & 4-5”, “1-3 & 5”, and the like. In addition, when a list of alternatives is positively provided, such a listing can also include embodiments where any of the alternatives may be excluded. For example, when a range of “1 to 5” is described, such a description can support situations whereby any of 1, 2, 3, 4, or 5 are excluded; thus, a recitation of “1 to 5” may support “1 and 3-5, but not 2”, or simply “wherein 2 is not included.”

For a variety of reasons, it is preferred that inventions (e.g. compositions and, uncured adhesive, precured adhesive and cured adhesive, methods and articles of manufacture) disclosed herein may be made in the absence of certain ingredients, and, i.e., be free of certain materials whether added or generated in situ other than minor amounts of contaminants, or may be free or substantially free from many ingredients used in compositions for ingredients for similar purposes in the prior art. Specifically, it is increasingly preferred in the order given, independently for each preferably minimized ingredient listed below, that at least some embodiments according to the invention contain no more than 1.0, 0.5, 0.35, 0.10, 0.08, 0.04, 0.02, 0.01, 0.001, or 0,0002 percent, more preferably said numerical values in grams per liter, more preferably said numerical values in ppm, of each of the following constituents: copper, imidazole, oxidizing agents such as peroxyacids, permanganate, perchlorate, chlorate, chlorite, hypochlorite, perborate, hexavalent chromium, trivalent chromium, sulfuric acid and sulfate, nitric acid and nitrate ions; as well as fluorine, formaldehyde, formamide, hydroxylamines, cyanides, cyanates; rare earth metals; boron, e.g. borax, borate; strontium; free halogen ions, e.g., fluoride, chloride, bromide or iodide; and/or epoxy curing accelerator comprising unsubstituted urea, an imidazole, dihydroxybenzene, adipic anhydride, phosphonium ionic liquid, unblocked tertiary amine or blocked tertiary amine active at ambient temperature, polyamine salts of polyhydric phenols, or a combination thereof.

As used herein, “diglycidyl ether of bisphenol-A” or “DGEBA” refers to 2,2-Bis(4-glycidyloxyphenyl) propane, an epoxy resin commercially available under tradenames Epon 828, D.E.R. 331, Kukdo YD-128. As used herein, “diglycidyl ether of bisphenol F” and “DGEBF” refer to Bis(4-glycidyloxyphenyl) methane, an epoxy resin commercially available under tradenames Epon 862 and D.E.R. 354s.

Unless otherwise specified, compositional percentages are in terms of weight percent, relative to the weight of the material or composition.

Abbreviations

| | |
|---|---|
| DGEBA | Diglycidyl ether of bisphenol-A |
| DGEBF | Diglycidyl ether of bisphenol F |
| PU | Polyurethane pre-polymer |
| CSR | Nano core shell rubber |
| MMT | Mixed mineral thixotrope |
| GLYMO | 3-Glycidyloxypropyl trimethoxysilane |
| CaO | Calcium oxide |
| DICY | Dicyandiamide |
| CTBN | Carboxyl-terminated butadiene-acrylonitrile |
| NER | Novolac epoxy resin |
| PEA | Polyetheramine |
| DMA | Dynamic mechanical analysis |
| T_{g} | Glass transition temperature |
| M_{c} | Molecular weight between cross-links |
| IWP | Impact wedge peel |
| DSC | Differential scanning calorimetry |
| OEM | Original Equipment Manufacturer |
| LB | Low bake |
| HB | High bake |
| CRS | Cold rolled steel |
| HDG | Hot dipped galvanized steel |

The present invention is further defined in the following Examples. It should be understood that these examples, while indicating preferred embodiments of the invention, are given by way of illustration only, and should not be construed as limiting the appended claims From the above discussion and these examples, one skilled in the art can ascertain the essential characteristics of this invention, and without departing from the spirit and scope thereof, can make various changes and modifications of the invention to adapt it to various usages and conditions.

### EXAMPLES

As those skilled in the art will appreciate, numerous modifications and variations of the present invention are possible in light of these teachings, and all such are contemplated hereby. The entire disclosures of each patent, patent application, and publication cited or described in this document are hereby incorporated herein by reference.

### Examples 1-4: DICY+Single Accelerator

Increasing the concentration of modified urea accelerator decreases the onset temperature of the cure reaction and thus can increase the extent of reaction under isothermal conditions at lower temperatures, as compared to lower concentrations of the modified urea accelerator. In these examples, a control structural adhesive (Comparative Example 1) and experimental adhesive formulations (Comparative Examples 2-4) were investigated to determine the influence of toughening agents and increased concentration of modified urea accelerator on structural adhesive properties using an adhesive cure window of 140° C. for 15 min. and 190° C. for 60 min. For each of the examples, two separate sets of specimens, three or more per set, were tested, one set was cured under the 140° C. conditions (low bake, “LB”) and a second set was cured at the 190° C. conditions (high bake, “HB”). Adhesion and impact testing on the cured sets was performed and the results provided below are average performance values of each set.

Table 1 formulations were made by a process of combining and mixing the listed components to create a homogeneous mass. First, the organic components, other than curatives, were combined and mixed under vacuum (8.5 kPa) until fully dissolved and/or dispersed homogenously. Thereafter, any inorganic fillers were added without vacuum, and the mixture was compounded under vacuum until homogeneous and free of entrapped gasses. The mixture was then allowed to cool to room temperature and the curative chemistries were incorporated into the mixture to form the 1K epoxy structural adhesive. Unless otherwise indicated herein, all adhesive formulations of the Examples were made according to this process.

TABLE 1
Comparative Examples containing increasing
concentration of 1,1-dimethyl urea.

| | Comparative Example | | | |
|---|---|---|---|---|
| Ingredient | 1 | 2 | 3 | 4 |
| | mass (g) | | | |
| DGEBA resin | 15.36 | 19.73 | 19.73 | 19.73 |
| CSR dispersion | 32.9 | 32.9 | 32.9 | 32.9 |
| CTBN-DGEBF adduct in DGEBF | 7.7 | 7.7 | 7.7 | 7.7 |
| PEA-DGEBA adduct | 10.39 | 10.39 | 10.39 | 10.39 |
| PU2 (60 wt. % in DGEBA resin) | 10.93 | 0 | 0 | 0 |
| PU1 | 0 | 6.56 | 6.56 | 6.56 |
| Mixed mineral thixotrope | 0.42 | 0.42 | 0.42 | 0.42 |
| GLYMO | 0.13 | 0.13 | 0.13 | 0.13 |
| Tricresyl phosphate | 2.69 | 2.69 | 2.69 | 2.69 |
| Calcium oxide | 5.19 | 5.19 | 5.19 | 5.19 |
| Mica | 0.25 | 0.25 | 0.25 | 0.25 |
| Pigment | 0.03 | 0.03 | 0.03 | 0.03 |
| Calcium metasilicate | 5.19 | 5.19 | 5.19 | 5.19 |
| Hydrophobic fumed silica | 3.78 | 3.78 | 3.78 | 3.78 |
| HGMs | 0.86 | 0.86 | 0.86 | 0 |
| 1,1-dimethyl urea | 0.72 | 0.72 | 1.44 | 2.16 |
| DICY | 3.46 | 3.46 | 3.46 | 3.46 |
| TOTAL: | 100 | 100 | 100.72 | 100.58 |
| | Concentration (wt. %) | | | |
| DGEBA | 43.63 | 43.63 | 43.31 | 43.37 |
| DGEBF | 6.16 | 6.16 | 6.12 | 6.12 |
| CSR | 13.2 | 13.2 | 13.1 | 13.1 |
| CTBN-DGEBF | 1.54 | 1.54 | 1.53 | 1.53 |
| PEA-DGEBA | 6.23 | 6.23 | 6.19 | 6.20 |
| PU2 | 6.56 | 0.00 | 0.00 | 0.00 |
| PU1 | 0.00 | 6.56 | 6.51 | 6.52 |
| 1,1-dimethyl urea | 0.72 | 0.72 | 1.43 | 2.15 |
| DICY | 3.46 | 3.46 | 3.44 | 3.44 |

The toughening agents PU1 and PU2 were both characterized as containing a polytetramethylene glycol (PTMEG) backbone. PU1 was described by the manufacturer as a bisphenol terminated polyurethane pre-polymer having a MW of about 10-20K Daltons. PU2 was a polyurethane pre-polymer end-capped asymmetrically with an oxime and a hydrophobic mono-phenolic functional groups and having a MW of about 10000 Daltons. PU2 exhibited a significantly lower deblock temperature than PU1 and had at least one endcap that was more hydrophobic than PU1 bisphenol end-caps.

Differential scanning calorimetry (hereinafter “DSC”) was used to determine the onset temperature and conversion kinetics of the cure reaction for each of Comparative Examples 1-4 adhesives. Firstly, 12±1 mg of adhesive was placed into a T-Zero® hermetic pan, which was sealed and placed into a DSC Q100 for a 10° C./min. ramp from 0 to 300° C. This linear temperature ramp was used to determine the reaction onset temperature and the enthalpy of reaction. Secondly, the same pan type and second mass of adhesive were used to prepare new samples to determine the extent of reaction as a function of time at 140° C. after a 7 min. ramp from 23° C. to 140° C. to simulate oven curing conditions under a new lower cure limit. Unless otherwise indicated herein, throughout the Examples, DSC results for exemplary adhesives were obtained using the above-described procedure.

TABLE 2
Differential scanning calorimetry (DSC) results

Comparative Examples

| | | | |
|---|---|---|---|
| 1 | 2 | 3 | 4 |

Ramp 0 to 300° C.

| | | | | |
|---|---|---|---|---|
| Reaction onset T | 161.4 | 161.3 | 152.8 | 147.4 |
| Reaction T | 173.1 | 173.3 | 167.8 | 164.1 |
| Exotherm (J/g) | 287.4 | 303.9 | 289.0 | 282.3 |

Isothermal hold 7 min. to 140° C.; hold for 60 min.

| | | | | |
|---|---|---|---|---|
| Time to peak exotherm (min.) | 22.0 | 23.2 | 14.4 | 11.7 |
| Exotherm (J/g) | 215.6 | 224.3 | 272.9 | 298.0 |

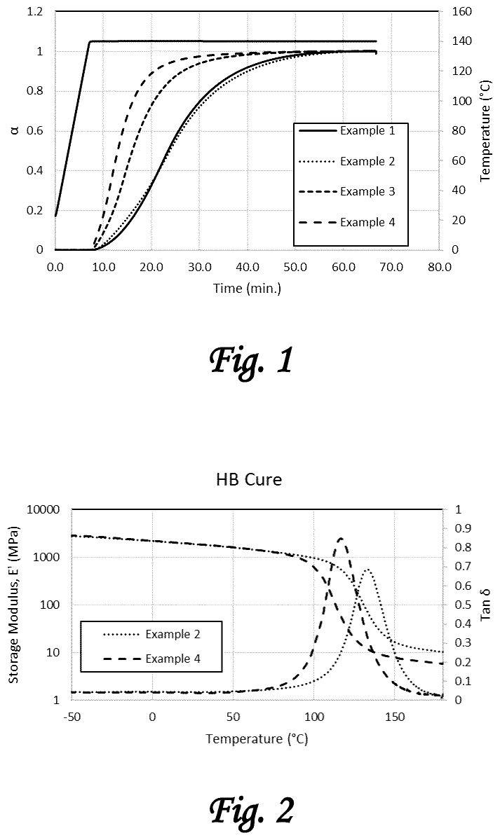

In the isothermal DSC experiment, the time to peak reaction exotherm and heat of reaction were determined using the instrument software. Finally, plots of extent of cure as a function of time were made from the isothermal DSC results. The extent of cure as a function of time for Comparative Examples 1-4 is shown in FIG. 1.

The results in Table 2 show that increased concentration of 1,1-dimethyl urea decreased the reaction onset temperature (linear ramp) and decreased the time to peak reaction exotherm under isothermal conditions at 140° C. (isothermal hold). Further, the enthalpy of reaction increased with increasing concentration of 1,1-dimethyl urea under isothermal conditions indicative of an increase in the extent of reaction at 140° C. The sigmoidal curves in FIG. 1 indicate that the extent of cure as a function of time increased with increasing concentration of modified urea. Interestingly, the linear ramp shows that the total enthalpy of reaction decreased with increasing concentration of 1,1-dimethyl urea.

The adhesion and impact properties for Comparative Examples 1-4 were tested for lap shear strength using the LSS test according to ASTM D1002; peel resistance was measured in N/mm using T-peel strength conditions of ASTM D1876-08(2015)e1, and resistance to cleavage fracture was measured in N/mm using the wedge impact method of ISO 11343.2019. Results are shown in Table 3A, “LB” indicating low bake and “HB” indicating high bake. Unless otherwise indicated herein, throughout the specification adhesives were tested using these tests.

TABLE 3A
Lap shear (LSS), T-peel and impact wedge peel (IWP) results

| | Comparative Examples (N/mm) | | | |
|---|---|---|---|---|
| | 1 | 2 | 3 | 4 |
| LB Cure, T-peel strength, 0.8 mm | 0.0 | 0.0 | 6.4 | 8.0 |
| HDG* | | | | |
| HB Cure, T-peel strength, 0.8 mm HDG | 10.1 | 10.2 | 10.8 | 8.0 |
| LB Cure, Lap shear strength, 1.3 mm | 0.0 | 0.0 | 24.6 | 29.2 |
| HDG | | | | |
| HB Cure, Lap shear strength, 1.3 mm | 36.2 | 33.3 | 33.7 | 31.0 |
| HDG | | | | |
| LB Cure, T-peel strength, 2.0 mm | 0 | 0 | 7.04 | 8.0 |
| 5754-A951-DC2-90 Al** | | | | |
| HB Cure, T-peel strength, 2.0 mm | 10.1 | 10.3 | 10.2 | 8.9 |
| 5754-A951-DC2-90 Al | | | | |
| LB Cure, Impact wedge peel strength | 0.0 | 0.0 | 27.0 | 28.0 |
| (test T = 23° C.), 0.8 mm CRS(cold | | | | |
| rolled steel) | | | | |
| HB Cure, Impact wedge peel strength | 42.9 | 38.7 | 40.3 | 31.6 |
| (test T = 23° C.), 0.8 mm CRS | | | | |
| LB Cure, Impact wedge peel strength | 0.0 | 0.0 | 2.6 | 16.3 |
| (test T = −40° C.), 0.8 mm CRS | | | | |
| HB Cure, Impact wedge peel strength | 22.1 | 21.4 | 4.8 | 0.0 |
| (test T = −40° C.), 0.8 mm CRS | | | | |

*HDG is hot dipped galvanized steel.
**5754-A951-DC2-90 Al is wrought Al/Mg alloy surface treated with A951 pretreatment and Drycote 2-90 dry film lubricant.

These results indicate that under the new ‘expanded cure window’ lower limit of 140° C. for 15 min. at ‘metal temperature’ (which takes approximately 7 min. in a standard oven), Comparative Examples 1 and 2 did not fully cure and failed to develop good adhesion and impact properties. However, Comparative Examples 3 and 4 showed that increasing the concentration of 1,1-dimethyl urea to concentrations greater than 1 and 2 wt. %, respectively, led to improved T-peel strength and lap shear strength after cure at 140° C. for 15 min. Also, Comparative Example 4 showed that incorporation of 1,1-dimethyl urea at a concentration greater than 2 wt. % leads to a sub-ambient impact wedge peel strength greater than 10 N/mm (−40° C. test temperature) after cure at 140° C. for 15 min. Correspondingly, examination of the data in FIG. 1 shows that after 15 min. at 140° C., Comparative Example 4 has an extent of conversion greater than 90%, while Comparative Example 3 shows an extent of conversion just under 80%. Therefore, >2 wt. % 1,1-dimethyl urea is desirable to develop good impact wedge peel properties (sub-ambient) after cure for 15 min. at 140° C.

Interestingly, an inverse relationship between the concentration of 1,1-dimethyl urea and the sub-ambient (−40° C.) IWP strength was observed after lower (LB) and high (HB) bake cure conditions, respectively. That is, the LB −40° C. IWP strength increases with increasing concentration of 1,1-dimethyl urea, but the HB −40° C. IWP strength decreases with increasing concentration of 1,1-dimethyl urea. This finding is important, since automotive OEMs require crash durability at both the upper and lower limits of the cure process window, despite their desire to decrease the lower limit cure requirement. Thus simple shifting of the existing process cure window to include LB, but foregoing HB, is not always sufficient to meet the needs of automotive OEMs and a balance of LB and HB performance in different test scenarios may be desirable.

Dynamic Mechanical Analysis (DMA) using a TA Q800 DMA and a dual cantilever fixture was used to better understand this phenomenon. The DMA data in FIG. 2 and the corresponding T_{g} and storage moduli at 40° C. and 180° C. for Comparative Examples 2 and 4 shown in Table 3B indicate that the concentration of accelerator had a strong influence on the thermoset network formation and structure.

TABLE 3B
Glass transition temperature (T_{g}) and storage
modulus (E′) at 40 and 180° C.

| Comparative | Cure | Tg | E′ at 40° C. | E′ at 180° C. |
|---|---|---|---|---|
| Example | Condition | (max tan δ) | (MPa) | (MPa) |
| 2 | HB Cure | 133.6 | 1703.2 | 10.2 |
| 4 | HB Cure | 116.8 | 1752.7 | 5.9 |

It was noted that the concentration of 1,1-dimethyl urea required for a good LB −40° C. IWP strength produced adhesive with a 16.8° C. decrease in Tg after cure at high bake conditions, which may be attributed to a significant increase in the molecular weight between cross-links (Mc). The value of E′ in the rubbery plateau (180° C.) decreased by 42.4%, indicative of a significant decrease in cross-link density. Therefore, the network properties achieved by the Comparative Example adhesive compositions required for good sub-ambient (−40° C.) impact wedge peel properties across the expanded lower bake and high bake cure conditions were not achieved by simply increasing the concentration of modified urea accelerator.

### Screening Latent Accelerator Additives

Over more than one year of extensive research, Applicant tested a variety of latent accelerator additives seeking to solve the problem of sufficient adhesive performance whether cured at lower bake, 140° C. for 15 min., or high bake, e.g. 190° C. for 60 min., conditions. Each accelerator additive or combination was incorporated into formulation the same basic formulation containing epoxy and DICY, in some instances with modified urea, and then evaluated for performance substantially as described in Example 1. Unless otherwise indicated, additive amounts were selected based on available literature and manufacturer publications. Tests performed were Lap Shear Strength (ASTM D1002), impact wedge peel strength (ISO 11343), reactivity via differential scanning calorimetry (DSC) and storage stability via parallel plate rheology test. Table 4 describes the performance of adhesive formulations that incorporated a listed latent accelerator additive and were cured at 140° C. for 15 min. or 190° C. for 60 min., respectively.

TABLE 4
Latent Accelerator Additive Screening Results

| Latent | | Performance Test Results |
|---|---|---|
| Accelerator | | Control 1K Epoxy-based Adhesive with DICY & |
| Additive | Description | Latent Accelerator Additive |
| Ajicure ™ PN-50 | Reaction product | Addition to adhesive formulation results in poorer impact |
| | of epoxy, | properties, especially at sub-ambient temperatures |
| | imidazole and | |
| | carboxylic acid | |
| Ajicure ™ PN-50 + | Reaction product | Adhesive baked at 140° C. metal temperature for 15 min. |
| modified urea | of epoxy, | failed Lap Shear Test with 50% cohesive failure showed |
| | imidazole and | poorer lap shear strength and failure mode (not 100% |
| | carboxylic acid | cohesive) vs. modified urea alone at the same total |
| | modified urea | accelerator concentration. |
| | Combination | |
| Curezol ™ | Modified | Adhesive baked at 140° C. metal temperature for 15 min. |
| 2MZ-Azine | imidazole | had poorer lap shear strength vs. modified urea and had |
| | | lower reactivity (per DSC), both at the same loading level |
| | | as modified urea |
| Curezol ™ | Modified | Adhesive baked at 140° C. metal temperature for 15 min. w |
| 2MZ-Azine + | imidazole | lower onset temp. but failed Lap Shear Test with 50% |
| modified urea | modified urea | cohesive failure and had poorer viscosity stability (parallel |
| | Combination | plate rheology test) than modified urea alone at the same |
| | | total accelerator concentration |
| Omicure ™ U52M | 4,4′ methylene | Adhesive showed 54% decrease in ISO 11343 impact |
| | bis-(phenyl | wedge peel strength as compared directly to modified |
| | dimethyl urea) | urea; concomitantly poorer failure mode. |
| Ladder Study | | |
| Ancamine ™ | 2014AS and | 2441 (5 phr (parts per hundred resin) DGEBA) |
| 2441 = | 2014FG = | 2014 AS (5 phr DGEBA) |
| modified polyamine, | modified | 2014 FG (5 phr DGEBA) |
| EEW38, Amine | polyamine, | Each adhesive baked at 140° C. metal temperature for 15 |
| val. 290 mg KOH/g | EEWS2, Amine | min. showed poor adhesion and lap shear strength. |
| 2337S modified | val. 184 mg | 2337S (5 phr DGEBA) + 2441 (5 phr DGEBA) |
| aliphatic amine, | KOH/g | |
| EEW85.5, Amine | 2337S = | 2337S (5 phr DGEBA) + 2014 AS (5 phr DGEBA) |
| val. 260 mg KOH/g, | modified | 2337S (5 phr DGEBA) + 2014 FG (5 phr DGEBA) |
| 10 phr DEGBA | aliphatic amine, | 10 phr total amount of accelerator DGEBA adhesive baked |
| polyamine alone | | at 140° C. metal temperature for 15 min. resulted in lower |
| 10 phr 2337S + | | lap shear strengths compared to use of modified urea; |
| 10 phr polyamine = | | adhesion failure mode was also observed. |
| 20 phr DGEBA | | 2441 (10 phr DGEBA) |
| | | 2014 AS (10 phr DGEBA) |
| | | 2014 FG (10 phr DGEBA) |
| | | 2337S (10 phr DGEBA) + 2441 (10 phr DGEBA) |
| | | 2337S (10 phr DGEBA) + 2014 AS (10 phr DGEBA) |
| | | 2337S (10 phr DGEBA) + 2014 FG (10 phr DGEBA) |
| | | Adhesive cured at 140° C. metal temperature for 15 min. |
| | | having 10 phr DGEBA of 2441, 2014AS and 2014FG alone |
| | | or a total of 20 phr DEGBA by addition of 10 phr 2337S, |
| | | respectively, resulted in poorer lap shear strength a |
| | | compared to modified urea alone at significantly lower |
| | | concentrations required to achieve the same accelerating |
| | | affect in DICY cured, structural adhesives. |
| K-pure CXC 1612 | Sb hexafluoride | Adhesive did not cure after 140° C. for 15 min. metal |
| | based catalyst | temperature when used ‘alone’ or in combination with |
| | | modified urea at 0.84 wt. % |
| CYPHOS IL ™ 104 | Phosphonium | Adhesives with phosphonium latent accelerators yielded |
| CYPHOS IL ™ 169 | ionic liquids | brittle adhesive networks. |
| Technicure ™ ADH | Adipic | Adhesive cured at 140° C. metal temperature for 15 min. |
| | dihydrazide | resulted in poor lap shear strengths, similar to ‘control’ |
| | (ADH) | structural adhesives designed for cure at higher |
| | | temperatures e.g. 190° C. |
| | | ADH adhesive had poorer viscosity stability vs. modified |
| | | urea accelerator alone. |
| Dihydroxy benzenes | Resorcinol | Adhesive compositions showed poor viscosity stability, |
| | 2,6-di tertbutyl | affected by “R” functional group and structure, & tended to |
| | phenol | gel or vitrify after ambient storage, with oxidation after air |
| | 2-tertbutyl-6- | contact. Adhesive cured at 140° C. metal temperature for 15 |
| | methyl phenol | min. showed suboptimal impact wedge peel strength at |
| | 2,5-di tertbutyl | sub-ambient temperature. |
| | hydroquinone | |
| Dihydroxy benzenes + | Combination | Similar performance to without modified urea. |
| modified urea | Resorcinol | |
| | modified urea | |
| Adeka ™ EH 3731S | Epoxy/amine | Cure failure: Adhesive did not cure (<1 wt. % cured) under |
| and 4358S | adducts | cure conditions of 140° C. metal temperature for 15 min. |
| Adeka ™ EH 3731S | Combination | Adhesive baked at 140° C. metal temperature for 15 min. |
| and 4358S + | Epoxy/amine | with 1.67 wt. % accelerator system (50 wt./wt. each |
| modified urea | adducts | accelerator class) cured, but at only 0.835 wt. % epoxy |
| | modified urea | adduct concentration showed suboptimal impact wedge |
| | | peel strength at −40° C., compared to 1.67 wt. % modified |
| | | urea alone. |

Each of the latent accelerator additive candidates had disadvantages when used in the amounts/combinations shown in Table 4 in one or more of reactivity for low temperature cure (LB), storage stability and good adhesive performance for a structural adhesive, i.e.: Lap Shear Strength, impact wedge peel strength & T-peel resistance. Epoxy amine adducts met some but not all test criteria for adhesive failure. The results showed the need for improvements in accelerator packages with DICY to produce a storage stable 1K structural adhesive that passes structural adhesive performance testing after cure in low temperature window of 140° C. for 15 min. while still retaining good adhesive performance when cured at high bake conditions of 190° C. for 60 min., respectively.

### Comparative Example 5 and Inventive Example 6

Applicant tested 2,4,6-Tris-(dimethylaminomethyl)phenol, a tertiary amine based on phenol accelerator, in an adhesive formulation made as described in Example 1. The tertiary amine accelerator provided excellent adhesion and ‘full spectrum’ impact properties across the expanded cure window of LB and HB. However, without rendering this accelerator latent, i.e. in the absence of blocking agent, encapsulation or the like, the adhesive formulation also fully cured at ambient temperature thus lacking sufficient storage stability for use as a 1K structural adhesive (even at low concentrations). Modifications to render the tertiary amine based on phenol accelerator heat activatable, but sufficiently stable at ambient temperature for use in a 1K adhesive and capable of accelerating DICY cure of epoxy resins in the desired cure window of LB and HB was investigated. Adhesive compositions containing the components listed in Table 5 were made according to the process of Example 1. Properties of the two adhesive formulations were compared, e.g. cure behavior, storage stability, adhesion, and impact properties of the adhesive formulations with different blocked tertiary amine based on phenol (e.g. tertiary aminophenol) latent reagents: A*-Tertiary aminophenol-blocked with novolac resin according to U.S. Pat. No. 9,000,120; and B*-Ancamine® 2920 (Evonik Corp.) described by the manufacturer as a 1K encapsulated accelerator comprising 25-50 wt. % tertiary amine, 25-50 wt. % polyhydroxyphenylalkyl polymer and 25-50 wt. % acrylic polymer used to accelerate DICY cure of epoxy resins.

TABLE 5
1K Adhesives containing different latent
tertiary amine based on phenol reagents

| | Comparative | |
|---|---|---|
| Ingredient; mass (g) | Example 5 | Example 6 |
| DGEBA resin | 15.17 | 15.17 |
| CSR dispersion | 32.53 | 32.53 |
| CTBN-DGEBF adduct in DGEBF | 7.61 | 7.61 |
| PEA-DGEBA adduct | 10.27 | 10.27 |
| PU2 (60 wt. % in DGEBA resin) | 10.8 | 10.8 |
| Phenyl isobutylated phosphate, triphenyl | 2.39 | 2.39 |
| phosphate (7.9% P) | | |
| Calcium oxide | 5.14 | 5.14 |
| Mica | 0 | 0 |
| Pigment | 0.03 | 0.03 |
| Calcium silicate | 5.14 | 5.14 |
| Hydrophobic fumed silica | 3.84 | 3.84 |
| GBs | 1.92 | 1.92 |
| HGMs | 0.9 | 0.9 |
| Tertiary amine with blocking A* | 2.52 | 0 |
| Tertiary amine with blocking B* | 0 | 2.52 |
| DICY | 3.42 | 3.42 |
| TOTAL: | 101.68 | 101.68 |
| | Concentration (wt. %) | |
| DGEBA | 42.40 | 42.40 |
| DGEBF | 5.99 | 5.99 |
| CSR | 12.8 | 12.8 |
| CTBN-DGEBF | 1.50 | 1.50 |
| PEA-DGEBA | 6.06 | 6.06 |
| PU2 | 6.37 | 6.37 |
| Tertiary amine with blocking A* | 2.48 | 0.00 |
| Tertiary amine with blocking B* | 0.00 | 2.48 |
| DICY | 3.36 | 3.36 |

Onset temperature and conversion kinetics of the cure reaction of adhesives of Comparative Example 5 and Example 6 were determined using DSC. The DSC results in Table 6 and the storage stability results in Table 7 show that the blocking chemistry played a role in both the reactivity and storage stability of the adhesive composition. The epoxy adhesive of Example 6 showed an improvement in reactivity and storage stability, as compared to Comparative Example 5. This result was surprising in that generally, as the reactivity of 1K heat cure, structural epoxy adhesives is increased, the storage stability is decreased.

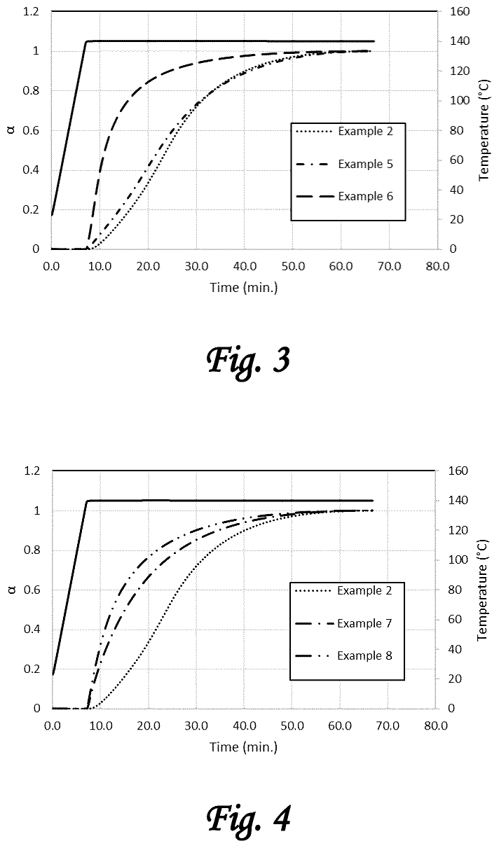

The isothermal conversion curves in FIG. 3 comparing 1K heat cure, structural epoxy adhesives with different accelerators shows that blocking chemistry A (“Comp. Example 5” without urea) facilitated a reactivity at 140° C. similar to alkyl modified urea (“Comp. Example 2”) utilized at a standard concentration (<1 wt. %). Example 6 adhesive showed a more rapid increase in the extent of conversion at shorter times under isothermal conditions at the expanded cure window lower limit.

TABLE 6
Differential scanning calorimetry (DSC) results

| | |
|---|---|
| Comparative Example 5 | Example 6 |

Ramp 0 to 300° C.

| | | |
|---|---|---|
| Onset T: | 154.2 | 133.6 |
| Reaction T: | 167.0 | 151.1 |
| Exotherm (J/g): | 259.2 | 292.3 |

Isothermal, 7 min. to 140° C.; hold for 60 min.

| | | |
|---|---|---|
| Time to peak exotherm (min.): | 20.0 | 8.8 |
| Exotherm (J/g): | 218.1 | 254.9 |

Storage stability is an important concern in producing a useful 1K adhesive curable at an adhesive cure window of 140° C. for 15 min. and 190° C. for 60 min., where significant increases in viscosity with aging may render the adhesive unusable. In Table 7, although Comparative Examples 2-4, provided lower aged viscosity, their time to peak exotherm ranged from 11.7 to 23.2 minutes, much longer delays than the adhesive of Example 6 exotherm of 8.8 min. Aged viscosity increase of Comparative Example 5 adhesive was greater than aged viscosity increase of Example 6 adhesive, despite Comp. Ex. 5 taking longer to reach peak exotherm. These performance criteria illustrate the challenges of obtaining desired reactivity at lower temperatures while achieving adequate storage stability.

TABLE 7
Storage stability results via parallel plate rheology
(15° C., 3 1/s shear rate, value at 180 seconds)

| | Compar- | Compar- | Compar- | Compar- | |
|---|---|---|---|---|---|
| | ative | ative | ative | ative | |
| | Exam- | Exam- | Exam- | Exam- | Exam- |
| | ple 2 | ple 3 | ple 4 | ple 5 | ple 6 |
| Initial viscosity | 2113.5 | 2195.2 | 2360.3 | 2132.1 | 2139.7 |
| (Pa*s) | | | | | |
| Viscosity after | 3777.5 | 3903.1 | 3990.9 | 6223.8 | 4901.5 |
| aging [7 days | | | | | |
| at 40° C.] | | | | | |
| (Pa*s) | | | | | |
| % Increase | 78.7 | 77.8 | 69.1 | 191.9 | 129.1 |

Further, the lap shear test results shown in Table 8 indicate that cured adhesive from Example 6 had a higher lap shear strength after LB cure than cured adhesive from Comparative Example 5. This may relate to differences in the extent of conversion (see FIG. 3) and the resulting cross-link density after low bake cure conditions.

TABLE 8
Lap shear strength results

| | Comparative | |
|---|---|---|
| | Example 5 | Example 6 |
| LB Cure, Lap shear strength, 1.3 mm HDG | 10.1 | 23.1 |
| HB Cure, Lap shear strength, 1.3 mm HDG | 33.4 | 31.5 |

### Examples 7 and 8

In the next set of adhesives made, polyurethane pre-polymer (PU1) was held constant, amount of Tertiary amine with blocking B was varied and urea amount was zero. Testing showed that including this polyurethane pre-polymer in combination with a particular curative composition provided improved T-peel adhesion and impact wedge peel properties as compared to PU2 (see Examples 9 and 10 below). Without being bound be a single theory, the improved T-peel and impact wedge peel are believed to be at least partly due to the increased MW of the soft segment of the PU1 pre-polymer that resulted in decreased cross-link density, improved interfacial fracture toughness and resulting adhesion. The differences in PU1 v. PU2 de-blocking temperatures also affects PU pre-polymer reactivity and adhesion properties.

TABLE 9
Epoxy adhesive compositions with different
amounts of Tertiary amine with blocking B

Example

| | | |
|---|---|---|
| Ingredient | 7 | 8 |

mass (g)

| | | |
|---|---|---|
| DGEBA resin | 19.73 | 19.73 |
| CSR dispersion | 32.9 | 32.9 |
| CTBN-DGEBF adduct in DGEBF | 7.7 | 7.7 |
| PEA-DGEBA adduct | 10.39 | 10.39 |
| PU1 | 6.56 | 6.56 |
| Mixed mineral thixotrope | 0.42 | 0.42 |
| GLYMO | 0.13 | 0.13 |
| Tricresyl phosphate | 2.69 | 2.69 |
| Calcium oxide | 5.19 | 5.19 |
| Mica | 0.25 | 0.25 |
| Pigment | 0.03 | 0.03 |
| Calcium silicate | 5.19 | 5.19 |
| Hydrophobic fumed silica | 3.78 | 3.78 |
| HGMs | 0.86 | 0.86 |
| Tertiary amine with blocking B* | 1.68 | 2.52 |
| DICY | 3.46 | 3.46 |
| TOTAL: | 100.96 | 101.8 |

Concentration (wt. %)

| | | |
|---|---|---|
| DGEBA | 43.21 | 42.85 |
| NER | 6.10 | 6.05 |
| CSR | 13.0 | 12.9 |
| CTBN-DGEBF | 1.53 | 1.51 |
| PEA-DGEBA | 6.17 | 6.12 |
| PU1 | 6.50 | 6.44 |
| Tertiary amine with blocking B* | 1.66 | 2.48 |
| DICY | 3.43 | 3.40 |

Onset temperature and conversion kinetics of the cure reaction of Examples 7 & 8 were determined using DSC. The DSC data in Table 10 shows that Examples 7 & 8 had different reaction onset temperature (ramp) and time to peak reaction (isotherm).

TABLE 10
Differential scanning calorimetry
(DSC) results for Examples 7 and 8.

Example

| | |
|---|---|
| 7 | 8 |

Ramp 0 to 300° C.

| | | |
|---|---|---|
| Onset T: | 137.7 | 131.6 |
| Reaction T: | 166.5 | 158.0 |
| Exotherm (J/g): | 271.2 | 270.1 |

Isothermal, 7 min. to 140° C.; hold for 60 min.

| | | |
|---|---|---|
| Time to peak exotherm (min.): | 7.7 | 7.1 |
| Exotherm (J/g): | 239.0 | 245.5 |

Storage stability of the epoxy adhesives of Examples 7 & 8 was tested, see Table 11 below showing storage stability comparable to modified urea, currently utilized in 1K crash durable adhesives.

TABLE 11
Storage stability results via parallel plate rheology
(15° C., 3 1/s shear rate, value at 180 seconds)

| | Example | |
|---|---|---|
| | 7 | 8 |
| Initial viscosity (Pa*s) | 2500.3 | 2644.9 |
| Viscosity after aging [7 days at 40° C.] (Pa*s) | 4634.3 | 5014.0 |
| % Increase | 85.3 | 89.6 |

Adhesion and impact properties for the epoxy adhesives of Examples 7 and 8 are shown in Table 12. Cured epoxy adhesives of Examples 7 & 8 exhibited only moderate lap shear strength and poor T-peel adhesion and impact wedge peel properties, especially at sub-ambient conditions, even at concentrations of greater than 2 wt. % of latent tertiary amine accelerator based on phenol, comprising 25-50 wt. % tertiary amine, 25-50 wt. % polyhydroxphenylalkyl polymer and 25-50 wt. % acrylic polymer. However, epoxy adhesives of Examples 7 & 8, compared favorably in HB cure impact wedge peel properties to epoxy adhesives accelerated with modified ureas (see Comparative Examples 2-4).

Further, the extent of conversion vs. time plots shown in FIG. 4 accounts for the poor LB cure fracture properties, since the data shows that the extent of cure after heating Examples 7 and 8 for 15 min. at 140° C. is 71.4% and 80.2%, respectively. Thus, the development of the desired adhesive fracture and adhesion properties after cure at 140° C. for 15 min. required excessive concentrations of this accelerator, which in turn led to increased viscosity growth under accelerated heat aging conditions.

TABLE 12
Lap shear, T-peel and impact wedge peel (IWP) results (N/mm)

| | Example | |
|---|---|---|
| | 7 | 8 |
| LB Cure, T-peel strength, 0.8 mm HDG | 0.8 | 2.1 |
| HB Care, T-peel strength, 0.8 mm HDG | 9.1 | 8.7 |
| LB Cure, Lap shear strength, 1.3 mm HDG | 11.2 | 18.6 |
| HB Cure, Lap shear strength, 1.3 mm HDG | 31.9 | 31.0 |
| LB Cure, T-peel strength, 2.0 mm 5754-A951-DC2-90 Al | 2.0 | 4.1 |
| HB Cure, T-peel strength, 2.0 mm 5754-A951-DC2-90 Al | 8.4 | 8.4 |
| LB Cure, Impact wedge peel strength (test T = 23° C.), | 0.0 | 11.5 |
| 0.8 mm CRS | | |
| HB Cure, Impact wedge peel strength (test T = 23° C.), | 34.7 | 34.3 |
| 0.8 mm CRS | | |
| LB Cure, Impact wedge peel strength (test T = −40° C.), | 0.0 | 0.0 |
| 0.8 mm CRS | | |
| HB Cure, Impact wedge peel strength (test T = −40° C.), | 18.3 | 15.6 |
| 0.8 mm CRS | | |

DMA was utilized to assess the thermoset network and impact properties after HB cure of epoxy adhesives of Exhibit 7& 8. The cure of epoxy resins with DICY and an accelerator is autocatalytic and thus the increased ramp rate to meet the HB cure temperature of 190° C. in equivalent time (7 min.) leads to rapid conversion of the available epoxy groups. Thus, a change in accelerator chemistry led to smaller differences in the reaction rate and as a result significant differences in adhesion and impact properties can be attributed to changes in network formation, rather than only cure kinetics.

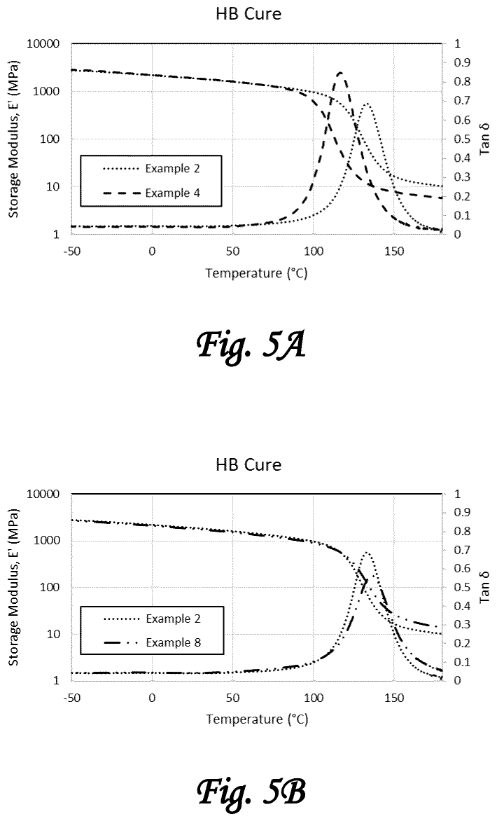

The DMA data in FIG. 5 for Comparative Examples 2 and 4, and Example 8 and the corresponding T_{g} and E′ values at 40 and 180° C. in Table 13 showed that the type and concentration of accelerator influences cross-link density of the adhesive and the resultant T_{g}.

Increased concentration of 1,1-dimethyl urea in epoxy adhesives (Comp. Ex. 2 v. Comp. Ex. 4) to decrease the reaction onset temperature and increase the cure reaction rate resulted in a 16.8° C. decrease in T_{g} after HB cure conditions. The decrease in T_{g} after HB (e.g. overbake) cure of the epoxy adhesive of Comparative Example 4 corresponded to a 42.2% decrease in storage modulus (E′) in the rubbery plateau (value taken at 180° C.). Thus, an increase in the concentration of modified urea led to a significant decrease in network cross-link density upon overbake cure conditions. In comparison, Example 8, containing no urea, had a T_{g} slightly higher than Comparative Example 2, along with a corresponding increase in the value of E′ at 180° C. in the rubbery plateau. A significant decrease in the T_{g} and cross-link density after HB cure conditions correlated with poor sub-ambient impact wedge peel properties of the cured epoxy adhesive, while acceleration of the reaction rate along with maintenance or even an increase in the extent of cross-linking observed in the control composition (Comparative Example 2) led to satisfactory impact wedge peel properties.

TABLE 13
Glass transition temperature (T_{g}) and storage modulus (E′) at
40 and 180° C. for Examples 2, 4 and 8, respectively.

| | Cure | Tg | E′ at 40° C. | E′ at 180° C. |
|---|---|---|---|---|
| Example | Condition | (max tan δ) | (MPa) | (MPa) |
| Comp. Ex. 2 | HB Cure | 133.6 | 1703.2 | 10.2 |
| Comp. Ex. 4 | HB Cure | 116.8 | 1752.7 | 5.9 |
| Example 8 | HB Cure | 136.5 | 1618.0 | 14.1 |

These results suggest that a particular combination of both 1,1-dimethyl urea and blocked tertiary amine based on phenol accelerators may facilitate maintenance of the advantageous control (Comparative Example 2) network properties while leading to a significant increase in the reaction rate under the new lower limit requirement (140° C. for 15 min.).

### Examples 9-11

The next set of epoxy adhesives investigated combination of 1,1-dimethyl urea with blocked tertiary amine based on phenol accelerators to facilitate control of network properties while increasing reaction rate under the new lower limit requirement (140° C. for 15 min.). Adhesive compositions containing the components listed in Table 14 were made according to the process of Example 1.

TABLE 14
Epoxy adhesive compositions with different Polyurethane
pre-polymers and a combined accelerator curative system

| | Example | | |
|---|---|---|---|
| Ingredient | 9 | 10 | 11 |
| | mass (g) | | |
| DGEBA resin | 15.36 | 19.73 | 19.73 |
| CSR dispersion | 32.9 | 32.9 | 32.9 |
| CTBN-DGEBF adduct in DGEBF | 7.7 | 7.7 | 7.7 |
| PEA-DGEBA adduct | 10.39 | 10.39 | 10.39 |
| PU2 (60 wt. % in DGEBA resin) | 10.93 | 0 | 0 |
| PU1 | 0 | 6.56 | 6.56 |
| Mixed mineral thixotrope | 0.42 | 0.42 | 0.42 |
| GLYMO | 0.13 | 0.13 | 0.13 |
| Tricresyl phosphate | 2.69 | 2.69 | 2.69 |
| Calcium oxide | 5.19 | 5.19 | 5.19 |
| Mica | 0.25 | 0.25 | 0.25 |
| Pigment | 0.03 | 0.03 | 0.03 |
| Calcium silicate | 5.19 | 5.19 | 5.19 |
| Hydrophobic fumed silica | 3.78 | 3.78 | 3.78 |
| HGMs | 0.86 | 0.86 | 0.86 |
| 1,1-dimethyl urea | 0.72 | 0.72 | 0.72 |
| Tertiary amine with blocking A* | 0 | 0 | 1.68 |
| Tertiary amine with blocking B* | 1.68 | 1.68 | 0 |
| DICY | 3.46 | 3.46 | 3.46 |
| TOTAL: | 101.68 | 101.68 | 101.68 |
| | Concentration (wt. %) | | |
| DGEBA | 42.91 | 42.91 | 42.91 |
| DGEBF | 6.06 | 6.06 | 6.06 |
| CSR | 12.9 | 12.9 | 12.9 |
| CTBN-DGEBF | 1.51 | 1.51 | 1.51 |
| PEA-DGEBA | 6.13 | 6.13 | 6.13 |
| PU2 | 6.45 | 0.00 | 0.00 |
| PU1 | 0.00 | 6.45 | 6.45 |
| 1,1-dimethyl urea | 0.71 | 0.71 | 0.71 |
| Tertiary amine with blocking A* | 0.00 | 0.00 | 1.65 |
| Tertiary amine with blocking B* | 1.65 | 1.65 | 0.00 |
| DICY | 3.40 | 3.40 | 3.40 |

Onset temperature and conversion kinetics of the cure reaction of Examples 9-11 were determined using DSC. The DSC results in Table 15 indicated that use of both 1,1-dimethyl urea and a tertiary amine based on phenol at concentrations less than 1 and 2 wt. %, respectively, resulted in an onset temperature similar to Example 7. A comparison of Example 11 DSC data to Comparative Example 5 (no urea) DSC data showed a synergy between 1,1-dimethyl urea and the tertiary amine accelerator based on phenol. The two accelerators synergistically contributed to accelerating the reaction, allowing for a lower concentration of each accelerator type (i.e. <3 wt. % of blocked tertiary amine based phenol and <| wt. % 1,1-dimethyl urea) to facilitate an improved balance between the storage stability, cure kinetics and network properties required for adhesion and impact wedge peel properties meeting performance requirements.

TABLE 15
Differential scanning calorimetry (DSC) results

Example

| | | |
|---|---|---|
| 9 | 10 | 11 |

Ramp 0 to 300° C.

| | | | |
|---|---|---|---|
| Onset T: | 140.3 | 137.2 | 150.3 |
| Reaction T: | 165.0 | 162.8 | 167.4 |
| Exotherm (J/g): | 288.8 | 287.8 | 287.0 |

Isothermal, 7 min. to 140° C.; hold for 60 min.

| | | | |
|---|---|---|---|
| Time to peak exotherm (min.): | 10.2 | 8.7 | 15.1 |
| Exotherm (J/g): | 229.8 | 212.8 | 214.5 |

The storage stability results for epoxy adhesives of Examples 9-11 are shown in Table 16. A comparison of viscosity changes of Example 9 (PU2) and Example 10) (PU1) showed the effects of the PU pre-polymer on viscosity stability. A comparison of viscosity changes of Examples 10 and 11 shows that the epoxy adhesive of Example 10 had better viscosity stability than the epoxy adhesive of Example 11.

TABLE 16
Storage stability results via parallel plate rheology
(15° C., 3 1/s shear rate, value at 180 seconds)

Example

| | 9 | 10 | 11 |
|---|---|---|---|
| Initial viscosity (Pa*s) | 2226.5 | 2458.1 | 2262.1 |
| Viscosity after aging [7 | 4050.7 | 5289.4 | 5493.3 |
| days at 40° C.] (Pa*s) | | | |
| % Increase | 81.9% | 115.2% | 142.8% |

It also was found that the PU pre-polymer plays an important role in the cured adhesive T-peel adhesion and impact wedge peel properties when incorporated in epoxy adhesives with the combined 1,1-dimethyl urea and blocked tertiary amine based on phenol. Table 17 shows cured performance testing of Examples 9-11 epoxy adhesive containing PU pre-polymer. Example 9 showed poorer performance than Example 10 in T-peel adhesion after cure at the lower limit (140° C., for 15 min.) and sub-ambient impact properties after cure at both extreme corners of the expanded cure window conditions (LB and HB).

TABLE 17
Lap shear, T-peel and impact wedge peel (IWP) results

| | Example (N/mm) | | |
|---|---|---|---|
| | 9 | 10 | 11 |
| LB Cure, T-peel strength, 0.8 mm HDG | 3.1 | 7.2 | 3.2 |
| HB Cure, T-peel strength, 0.8 mm HDG | 9.3 | 10.0 | 10.3 |
| LB Cure, Lap shear strength, 1.3 mm HDG | 21.0 | 21.8 | 27.5 |
| HB Cure, Lap shear strength, 1.3 mm HDG | 32.2 | 33.3 | 32.4 |
| LB Cure, T-peel strength, 2.0 mm | 5.7 | 7.1 | 5.5 |
| 5754-A951-DC2-90 Al | | | |
| HB Cure, T-peel strength, 2.0 mm | 8.7 | 9.4 | 10.0 |
| 5754-A951-DC2-90 Al | | | |
| LB Cure, Impact wedge peel strength | 24.1 | 27.3 | 20.9 |
| (test T = 23° C.), 0.8 mm CRS | | | |
| HB Cure, Impact wedge peel strength | 37.2 | 36.5 | 40.2 |
| (test T = 23° C.), 0.8 mm CRS | | | |
| LB Cure, Impact wedge peel strength | 1.3 | 10.3 | 0.0 |
| (test T = −40° C.), 0.8 mm CRS | | | |
| HB Cure, Impact wedge peel strength | 5.4 | 17.7 | 16.3 |
| (test T = −40° C.), 0.8 mm CRS | | | |

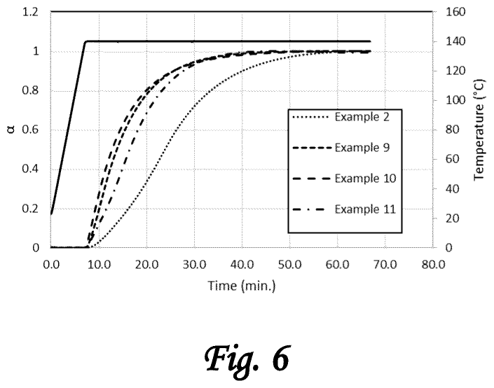

This performance difference was not attributable to poor extent of conversion upon LB cure, since the Examples 9 and 10 showed the same reaction onset temperature via the DSC experiments. Further, the extent of conversion as a function of time curves in FIG. 6 show that the same extent of conversion took place after cure at 140° C. for 15 min for Examples 9 and 10. Finally, it was also observed that after HB cure, adhesives that contained PU2 had poorer sub-ambient impact properties compared to adhesives containing PU1.

### Examples 12 and 13

Adhesive compositions containing the components listed in Table 18 were made according to the process of Example 1. PU1 and PU2 were compared directly in an adhesive composition with no other toughening agents, e.g. no CTBN, CSR or the like, to isolate performance differences related to the PU pre-polymer on the expanded cure structural adhesive composition properties.

TABLE 18
Influence of PU pre-polymer composition on adhesion and impact
properties with dual accelerators for expanded cure.

Example

| Ingredient mass (g) | 12 | 13 |
|---|---|---|
| DGEBA resin | 41.2 | 54.46 |
| PU2 (60 wt. % in DGEBA resin) | 32.35 | 0 |
| PU1 | 0 | 19.48 |
| Phenyl isobutylated phosphate, | 2.35 | 2.35 |
| triphenyl phosphate (7.9% P) | | |
| Calcium oxide | 5.04 | 5.04 |
| Pigment | 0.03 | 0.03 |
| Calcium silicate | 5.04 | 5.04 |
| Hydrophobic fumed silica | 3.76 | 3.76 |
| GBs | 1.88 | 1.88 |
| 1,1-dimethyl urea | 0.50 | 0.50 |
| Ancamine ® 2920 | 1.68 | 1.68 |
| DICY | 3.67 | 3.67 |
| TOTAL: | 97.5 | 97.89 |

Concentration (wt. %)

| | | |
|---|---|---|
| DGEBA | 55.53 | 55.63 |
| PU2 | 19.91 | 0.00 |
| PU1 | 0.00 | 19.90 |
| 1,1-dimethyl urea | 0.51 | 0.51 |
| Ancamine ® 2920 | 1.72 | 1.72 |
| DICY | 3.76 | 3.75 |

Performance test data of the cured epoxy adhesives of Examples 12 & 13 are shown in Table 19. Example 13 exhibited significantly improved T-peel adhesion and impact wedge peel results across the expanded cure window conditions of interest (140° C. for 15 min, and 190° C. for 60 min., respectively) compared to Example 12, as formulated with the curative system including both 1,1-dimethyl urea and a blocked tertiary amine based on phenol.

TABLE 19
Lap shear, T-peel and impact wedge peel (IWP) results

| | Example | |
|---|---|---|
| | 12 | 13 |
| LB Cure, T-peel strength, 0.8 mm HDG | 4.0 | 9.5 |
| HB Cure, T-peel strength, 0.8 mm HDG | 3.5 | 9.6 |
| LB Cure, Lap shear strength, 1.3 mm HDG | 22.1 | 26.1 |
| HB Cure, Lap shear strength, 1.3 mm HDG | 23.3 | 27.8 |
| LB Cure, Impact wedge peel strength (test T = 23° C.), 0.8 | 27.8 | 35.6 |
| mm CRS | | |
| HB Cure, Impact wedge peel strength (test T = 23° C.), 0.8 | 10.1 | 35.9 |
| mm CRS | | |

### Example 14

Improvements in storage stability while maintaining adhesive fracture properties ater cure were investigated. Examples 10 and 14 directly compare two differing CSR compositions available from Kaneka Corporation.

TABLE 20
Comparison of Effect of Different CSR
materials at 12.9 wt. %, respectively.

| | Example | |
|---|---|---|
| Ingredient | 10 | 14 |
| | mass (g) | |
| DGEBA resin | 19.73 | 23.39 |
| CSR dispersion, 40 wt. % CSR in DGEBA* | 32.9 | 0 |
| CSR dispersion, 45 wt. % CSR in DGEBA** | 0 | 29.24 |
| CTBN-DGEBF adduct in DGEBF | 7.7 | 7.7 |
| PEA-DGEBA adduct | 10.39 | 10.39 |
| PU1 | 6.56 | 6.56 |
| Mixed mineral thixotrope | 0.42 | 0.42 |
| GLYMO | 0.13 | 0.13 |
| Tricresyl phosphate | 2.69 | 2.69 |
| Calcium oxide | 5.19 | 5.19 |
| Mica | 0.25 | 0.25 |
| Pigment | 0.03 | 0.03 |
| Calcium silicate | 5.19 | 5.19 |
| Hydrophobic fumed silica | 3.78 | 3.78 |
| HGMs | 0.86 | 0.86 |
| 1,1-dimethyl urea | 0.72 | 0.72 |
| Ancamine ® 2920 | 1.68 | 1.68 |
| DICY | 3.46 | 3.46 |
| TOTAL: | 101.68 | 101.68 |
| | Concentration (wt. %) | |
| DGEBA | 42.91 | 27.09 |
| DGEBF | 6.06 | 6.06 |
| CSR | 12.9 | 12.9 |
| CTBN-DGEBF | 1.51 | 1.51 |
| PEA-DGEBA | 6.13 | 6.13 |
| PU1 | 6.45 | 6.45 |
| 1,1-dimethyl urea | 0.71 | 0.71 |
| Ancamine ® 2920 | 1.65 | 1.65 |
| DICY | 3.40 | 3.40 |

*Kane Ace MX-154 described as 40 wt. % CSR dispersion in Bisphenol A;
**Kane Ace MX-EXP-EH2 (Kane Ace MX-160) described as 45 wt. % CSR dispersion in Bisphenol A; both from Kaneka Corporation.

Storage stability of the epoxy adhesives of Examples 10 & 14 was tested, see Table 21 below. Surprisingly, it was found that a change in the CSR composition led to significant improvements in storage stability while retaining adhesion and impact wedge peel properties after cure under the expanded cure window conditions of interest (15 min. at 140° C. and 60 min. at 190° C., respectively).

TABLE 21
Storage stability results via parallel plate rheology
(15° C., 3 1/s shear rate, value at 180 seconds)

| | Example | |
|---|---|---|
| | Example 10 | Example 14 |
| Initial viscosity (Pa*s) | 2648.2 | 1789.5 |
| Viscosity after aging [7 days at 35° C.] | 3731.8 | 2338.2 |
| (Pa*s) | | |
| % Increase | 40.9% | 30.7% |
| Viscosity after aging [14 days at 35° C.] | 4421.1 | 2561.9 |
| (Pa*s) | | |
| % Increase | 66.9 | 43.2 |
| Viscosity after aging [28 days at 35° C.] | 5361.2 | 2863.3 |
| (Pa*s) | | |
| % Increase | 102.5 | 60.0 |
| Viscosity after aging [42 days at 35° C.] | 6710.0 | 3730.7 |
| (Pa*s) | | |
| % Increase | 153.4 | 109.0 |
| Viscosity after aging [70 days at 35° C.] | ND | 4878.5 |
| (Pa*s) | | |
| % Increase | ND | 172.6 |

Storage stability results in Table 21 show that Example 14 exhibited a reduced ‘initial’ viscosity (the viscosity of the adhesive directly after compounding) compared to Example 10. Under accelerated heat aging conditions, Exhibit 14 also exhibited both lower viscosity than Example 10 and a lesser percentage viscosity increase after aging. The improvement in viscosity stability may be attributable to a decrease in the relative proportion of functional groups on the surface of the CSR particles. This improvement in storage stability is advantageous since the viscosity of the adhesive composition desirably remains below 5,000 Pa*s at 15° C. and 3 1/s shear rate through the adhesive shelf life; a value below 4,000 Pas at 15° C. and 3 1/s shear rate is preferred.

The T-peel adhesion and impact wedge peel properties of the epoxy adhesive of Example 14 are shown in Table 22 indicate that a direct replacement of the Kane Ace MX-154 CSR particles with Kane Ace MX-EXP-EH2 (Kane Ace MX-160) CSR particles did not have a deleterious influence on initial adhesion and impact peel results. See, Table 17, Example 10 performance in T-peel adhesion and impact wedge peel testing for a direct comparison.

TABLE 22
T-peel and impact wedge peel (IWP) results (N/mm)

| | Example 14 |
|---|---|
| LB Cure, T-peel strength, 0.8 mm HDG | 6.3 |
| HB Cure, T-peel strength, 0.8 mm HDG | 9.7 |
| LB Cure, T-peel strength, 2.0 mm 5754-A951-DC2-90 Al | 7.0 |
| HB Cure, T-peel strength, 2.0 mm 5754-A951-DC2-90 Al | 9.5 |
| LB Cure, Impact wedge peel strength (test T = 23° C.), | 24.8 |
| 0.8 mm CRS | |
| HB Cure, Impact wedge peel strength (test T = 23° C.), | 39.2 |
| 0.8 mm CRS | |

### Examples 15-18

Adhesive compositions containing the components listed in Table 23 were made according to the process of Example 1.

TABLE 23
Epoxy Adhesive Compositions comprising a Latent
Reactant in addition to DICY and urea

| | Example | | | |
|---|---|---|---|---|
| Ingredient | 15 | 16 | 17 | 18 |
| | mass (g) | | | |
| DGEBA resin | 20.39 | 20.39 | 17.17 | 17.17 |
| CSR dispersion, 45 wt. % CSR | 29.24 | 29.24 | 35.1 | 35.1 |
| in DGEBA | | | | |
| CTBN-DGEBF adduct in DGEBF | 7.7 | 7.7 | 7.7 | 7.7 |
| Polyetheramine-DGEBA adduct | 10.39 | 10.39 | 10.39 | 10.39 |
| PU1 | 9.56 | 9.56 | 9.56 | 0 |
| PU3 | 0 | 0 | 0 | 9.56 |
| Mixed mineral thixotrope | 0.42 | 0.42 | 0.42 | 0.42 |
| GLYMO | 0.13 | 0.13 | 0.13 | 0.13 |
| Tricresyl phosphate | 2.69 | 2.69 | 2.69 | 2.69 |
| Calcium oxide | 5.19 | 5.19 | 5.19 | 5.19 |
| Mica | 0.25 | 0.25 | 0.25 | 0.25 |
| Pigment | 0.03 | 0.03 | 0.03 | 0.03 |
| Calcium silicate | 5.19 | 5.19 | 5.19 | 5.19 |
| Hydrophobic fumed silica | 3.78 | 3.78 | 3.78 | 3.78 |
| HGMs | 0.86 | 0.86 | 0.86 | 0.86 |
| 1,1-dimethyl urea | 0.72 | 0.72 | 0.72 | 0.72 |
| Tertiary amine with blocking B* | 1.68 | 2.1 | 2.1 | 2.1 |
| DICY | 3.33 | 3.33 | 3.33 | 3.33 |
| TOTAL: | 101.55 | 101.97 | 104.61 | 104.61 |
| | Concentration (wt. %) | | | |
| DGEBA | 24.17 | 24.07 | 20.39 | 20.39 |
| DGEBF | 6.07 | 6.04 | 5.89 | 5.89 |
| CSR | 13.0 | 12.9 | 15.1 | 15.1 |
| CTBN-DGEBF | 1.52 | 1.51 | 1.47 | 1.47 |
| PEA-DGEBA | 6.14 | 6.11 | 5.96 | 5.96 |
| PU1 | 9.41 | 9.38 | 9.14 | 0 |
| PU3* | 0 | 0 | 0 | 9.14 |
| 1,1-dimethyl urea | 0.71 | 0.71 | 0.69 | 0.69 |
| Tertiary amine with blocking B* | 1.65 | 2.06 | 2.01 | 2.01 |
| DICY | 3.28 | 3.27 | 3.18 | 3.18 |

*PU3 was a polyurethane pre-polymer having a MW of about 2000, end-capped with hydrophobic mono-phenolic functional groups.

Performance test data of the cured epoxy adhesives of Examples 15-18 are shown in Table 24 and exhibited significant improvement in sub-ambient (−40° C.) impact wedge peel properties as compared to Table 17, Example 10 performance,

TABLE 24
Impact wedge peel properties

| | Example (N/mm) | | | |
|---|---|---|---|---|
| | 15 | 16 | 17 | 18 |
| LB Cure, Impact wedge peel strength | 9.0 | 15.3 | 22.2 | 19.5 |
| (test T = −40° C.), 0.8 mm CRS | | | | |
| HB Cure, Impact wedge peel strength | 27.9 | 26.0 | 23.6 | 20.7 |
| (test T = −40° C.), 0.8 mm CRS | | | | |

Another set of adhesive compositions containing the components listed in Table 23, Ex. 18 were made according to the process of Example 1, modified as follows: Tertiary amine with blocking B was omitted and various amounts of latent reactant (Examples 19, 20 & 21 @ 2.0, 2.5 & 3.5 wt. %, respectively) described by the manufacturer as an amine epoxy adduct were used instead. Onset temperature, tested by DSC, was 145, 140 and 132° C., respectively, showing good low temperature reactivity in the desired bake window. Ex. 19-21 adhesives were aged for 14 days at 35° C.′, and stability tested for rheology increase, as described herein, see Table 21. Viscosity increase for Ex. 19-21 was in a range of 34% to 50%, which was comparable to stability provided by other latent reactants in comparable adhesive formulations according to the invention, see Tables 7, 11, 16 & 21. Impact wedge peel for Ex. 19-21 adhesives cured at 140° C./15 min bake was tested at 23° C. per ISO 11343.2019 and impact resistance was in a range of 15-20 N/mm, which may be useful as structural adhesive in hem flanges, epoxy adhesive tapes and expandable epoxy structural adhesives useful in vehicle construction.

The skilled artisan will understand that the foregoing Examples are merely embodiments illustrating the inventions components and performance. They are in no way intended to limit the invention to the exemplary embodiments.

What is claimed is:

1. A structural adhesive composition useful in vehicle construction comprising:
(i) an epoxy resin comprising a diglycidyl ether of a substituted or unsubstituted bisphenol;
(ii) latent reactant;
(iii) a modified urea accelerator;
(iv) dicyandiamide;
(v) at least one toughening agent;
(vi) optionally at least one filler; and
(vii) optionally an epoxy resin different from (i).

2. The adhesive composition of claim 1, wherein the epoxy resin (i) has an epoxide equivalent weight (EEW) of about 150 to about 225.

3. The adhesive composition of claim 1, wherein the epoxy resin (i) comprises a diglycidyl ether of bisphenol-A (DGEBA), a diglycidyl ether of bisphenol F (DGEBF) or combinations thereof.

4. The adhesive composition of claim 1, wherein the adhesive composition lacks an accelerator that is an imidazole, dihydroxybenzene, adipic anhydride, phosphonium ionic liquid, blocked tertiary amine based on the phenol lacking an acrylate, polyamine salts of polyhydric phenols, or a combination thereof.

5. The adhesive composition of claim 2, comprising two, three, four or more of the epoxy resin (i), different from each other.

6. The adhesive composition of claim 1, comprising about 30 to about 60 wt. %, based on the weight of the composition, of the epoxy resin (i).

7. The adhesive composition of claim 1, wherein the latent reactant is a heat activatable reagent comprising is a modified polymeric tertiary amine having an activation temperature in a range of about 120° C. to about 138° C.

8. The adhesive composition of claim 1, wherein the latent reactant is a heat activatable reagent comprising a tertiary amine, a polyhydroxyphenylalkyl polymer resin and a supplemental organic agent.

9. The adhesive composition of claim 8, wherein the supplemental organic agent comprises an oligomer or a polymer comprising acryl moieties.

10. The adhesive composition of claim 8, wherein the tertiary amine comprises at least one hydroxyl substituent.

11. The adhesive composition of claim 8, wherein the tertiary amine comprises an aromatic ring and an acrylate.

12. The adhesive composition of claim 8, wherein the tertiary amine comprises an aromatic ring having 1-3 tertiary amine functional groups, optionally further comprising at least one hydroxyl substituent.

13. The adhesive composition of claim 8, wherein the tertiary amine comprises one or more of mono-, di- or tris-(dialkylaminomethyl)-phenol.

14. The adhesive composition of claim 13, wherein the tertiary amine comprises 2,4,6-tris-(dimethylaminomethyl)-phenol.

15. The adhesive composition of claim 1, comprising about 0.5 to about 5 wt. %, based on the weight of the composition, of the latent reactant.

16. The adhesive composition of claim 1, wherein the modified urea accelerator comprises a dimethylurea.

17. The adhesive composition of claim 1, comprising about 0.2 to about 3 wt. %, based on the weight of the composition, of the modified urea accelerator.

18. The adhesive composition of claim 1, comprising about 2 to about 6 wt. %, based on the weight of the composition, of the dicyandiamide.

19. The adhesive composition of claim 1, wherein the at least one toughening agent (v) is present in an amount of about 1 to about 20 wt. %, based on the weight of the composition and comprises at least one carboxyl terminated butadiene acrylonitrile (CTBN), optionally adducted with DGEBF and/or DGEBA.

20. The adhesive composition of claim 1, further comprising a flexibilizer wherein the flexibilizer is a polyetheramine-DGEBA adduct.

21. The adhesive composition of claim 1, further comprising core shell rubber (CSR) particles solid toughening agent, optionally dispersed in an epoxy resin.

22. The adhesive composition of claim 21, comprising about 20 to about 25% by weight, based on the weight of the composition, of CSR particles.

23. The adhesive composition of claim 21, wherein the CSR particles are nano core shell rubber particles.

24. The adhesive composition of claim 22, wherein the CSR particles are dispersed in DGEBA.

25. The adhesive composition of claim 24, comprising about 40 to about 45 wt. %, based on the weight of the CSR particles in DGEBA, of CSR particles.

26. The adhesive composition of claim 1, comprising a polyurethane toughening agent in an amount of about 0.1 to about 34 wt. %, based on the weight of the composition.

27. The adhesive composition of claim 26, wherein the polyurethane toughening agent is a blocked polyurethane toughening agent.

28. The adhesive composition of claim 26, wherein the toughening agent comprises one or more polyurethane pre-polymers based on (poly(tetramethylene ether)glycol and/or polybutadiene, optionally end-capped.

29. The adhesive composition of claim 1, further comprising a phosphorus adhesion promoter in an amount of about 0.5 to about 5 wt. %, based on the weight of the composition.

30. The adhesive composition of claim 29, wherein the phosphorus adhesion promoter comprises a substituted or unsubstituted triphenyl phosphate.

31. The adhesive composition of claim 29, wherein the phosphorus adhesion promoter comprises at least one tris(alkylphenyl) phosphate.

32. The adhesive composition of claim 31, wherein the phosphorus adhesion promoter comprises one or more of tris(4-isopropylphenyl) phosphate, tris[4-(2-methylpropyl)phenyl] phosphate, or triphenyl phosphate.

33. The adhesive composition of claim 1, further comprising a silane adhesion promoter in an amount of about 0.1 to about 0.3 wt. %, based on the weight of the composition.

34. The adhesive composition of claim 33, wherein the silane adhesion promoter is 3-glycidyloxypropyltrimethoxy silane (GLYMO).

35. The adhesive composition of claim 1, wherein the at least one filler is present and comprises an inorganic filler present in an amount of about 1 to about 35 wt. %, based on the weight of the composition.

36. The adhesive composition of claim 35 wherein the inorganic filler comprises calcium oxide, calcium metasilicate, mica, mixed mineral thixotrope, hydrophobic surface treated fumed silica, hollow glass microspheres, or a combination thereof.

37. The adhesive composition of claim 35, wherein the inorganic filler is a desiccant, thixotrope, or a combination thereof.

38. The adhesive composition of claim 35, comprising:
a. about 1 to about 10 wt. %, based on the weight of the composition, of calcium oxide;
b. about 1 to about 10 wt. %, based on the weight of the composition, of calcium metasilicate;
c. about 0.1 to about 1 wt. %, based on the weight of the composition, of mica;
d. about 0.1 to about 1 wt. %, based on the weight of the composition, of a mixed mineral thixotrope;
e. about 1 to about 8 wt. %, based on the weight of the composition, of hydrophobic surface treated fumed silica;
f. about 0.5 to about 3 wt. %, based on the weight of the composition, of hollow glass microspheres; or
a combination of two or more thereof.

39. The adhesive composition of claim 1, wherein:
(i) the epoxy resin comprising a diglycidyl ether of a substituted or unsubstituted bisphenol is present in an amount of about 30 wt. % to about 60 wt. %;
(ii) the latent reactant is present in an amount of about 0.25 to about 5 wt. %;
(iii) the modified urea accelerator is present in an amount of about 0.2 to about 3 wt. %;
(iv) the dicyandiamide is present in an amount of about 1.5 to about 6 wt. %;
(v) the at least one toughening agent is present in an amount of about 1 to about 20 wt. % CTBN and/or about 1 to about 25 wt. % of CSR particles and/or about 0.1 to about 34 wt. % of a polyurethane toughening agent;
(vi) the at least one filler is present in an amount of about 1 to about 35 wt. %; and
(vii) the epoxy resin different from (i) is present as a novolac epoxy resin having an EEW ranging from 172 to 225;
wherein all amounts are based on weight of the composition and wherein the adhesive composition is storage stable at ambient temperatures, or stable in a range of 15° C. to 30° C.

40. A method of preparing a cured adhesive, comprising heating the adhesive composition of claim 1 to a temperature of about 140° C. to about 150° C., wherein the adhesive composition is heated to about 140° C. for 15 minutes optionally further comprising heating to 190° C. for 60 minutes.

41. A product prepared using the method of claim 40.

42. An article of manufacture comprising a first surface and a second surface and sandwiched between the first and second surfaces and adhering them together is a cured layer of the adhesive composition according to claim 1.

43. The article of manufacture of claim 42, wherein one or both of the first and second surfaces comprises metal surfaces, composite surfaces or a combination thereof.

44. The article of manufacture of claim 42, wherein one or both of the first and second surfaces comprises metal, coated metal, aluminum, plastic, filled plastic, or fiberglass surfaces.

45. The article of manufacture of claim 42, which is a component of an aerospace, automotive, marine, locomotive or construction vehicle, preferably an automobile component.
